(19) United States
(12) Patent Application Publication
(10) Pub. No.: US 2021/0272193 A1
(43) Pub. Date: Sep. 2, 2021

(54) SYSTEMS AND METHODS FOR ELECTRONICALLY UNDERWRITING LOAN APPLICATION INFORMATION FROM, AND POSTING LOAN PRODUCTS OF LENDERS TO, LOAN APPLICATION WEBPAGES

(71) Applicant: Alejandro Espinoza, Scottsdale, AZ (US)

(72) Inventor: Alejandro Espinoza, Scottsdale, AZ (US)

(21) Appl. No.: 16/806,762

(22) Filed: Mar. 2, 2020

(51) Int. Cl. G06Q 40/02; G06Q 30/06; H04N 21/478

(52) U.S. Cl. CPC G06Q 40/025; H04N 21/47805; G06Q 30/0637; G06Q 30/0641

(57) ABSTRACT

An electronic loan underwriting system includes a computer warehouse serving a webpage and containing loan stores each including lending criteria and loan products of a lender, and a processor coupled to the computer warehouse and the webpage and programmed to receive from a web browser of a computer user loan application information about a borrower applying for a loan and for each of the loan stores as the loan application information is being received by the processor both automatically a) compare the loan application information to the lending criteria and b) selectively post the loan products to the webpage on-the-go in real-time upon the loan application information corresponding to the lending criteria.

### FIELD OF THE INVENTION

The present invention relates to financing, the act of obtaining or furnishing money for a purchase or enterprise.

More particularly, the present invention relates to underwriting loans, including consumer loans, commercial loans, and mortgage loans.

In a further and more specific aspect, the present invention relates to systems and methods for electronically underwriting loan application information and selectively posting loan products of lenders to webpages from a loan content provider in communication with the webpages on-the-go in real-time during entry of loan application information to the loan content provider from the webpages.

### BACKGROUND OF THE INVENTION

Secured loans are backed by an asset, like a house in the case of a mortgage loan, a vehicle with an auto loan, a boat with a marine or boat loan, etc. The asset constitutes collateral for the loan. When a borrower agrees to a secured loan, the borrower agrees to allow the lender to repossess the collateral if he fails to repay the loan as agreed. Even though lenders repossess property for defaulted secured loans, the debtor could still owe money on the defaulted loan. When lenders repossess property, they sell it and use the proceeds to satisfy the loan. If the property fails to sell for enough money to discharge, the debtor remains responsible for the outstanding balance of the loan.

One of the most common form of secured loan is the automobile/vehicle loan. Most consumers finance vehicle purchases; they borrow the money from a lender to pay for the vehicle and then pay off the lender in installments. There are two principal methods of borrowing money for a vehicle purchase: direct, in which a borrower arranges a loan with a lender directly, and indirect, in which a vehicle dealership arranges financing between a borrower and a lender. When a buyer obtains financing arranged by a dealership, the buyer and dealership execute a retail installment sales contract which the dealer sells or assigns to a lender, such as a bank, a credit union, or other financial institution. Usually, the dealership knows in advance the lender institution that will buy the contract. The borrower then pays off the lender like a direct loan. With indirect financing, the dealership typically sets an interest rate, known as the “buy rate,” adds a markup to that rate, and presents the result to the consumer as the “contract rate.” These markups have been the focus of some regulatory scrutiny because they can cause variations in interest rates not correlated with credit risk. Captives, financing arms of vehicle manufacturers, finance half of all new vehicle sales in the United States, followed by banks, credit unions, and finance companies. Dealerships finance a small number of vehicles, approximately 6%. These “buy here pay here” dealerships cater to customers with subprime credit.

Vehicle loans are secured or collateralized loan. A secured or collateralized loan is a loan in which a borrower pledges the vehicle as collateral, the security pledged for the payment of the loan by the borrower to the lender. The collateral, the vehicle, secures the debt of the secured loan. If the debtor defaults, the lender can take possession of vehicle and sell it to fully or partially discharge the outstanding debt. If the sale of the vehicle fails to satisfy the debt, the lender can obtain a deficiency judgement against the borrower for the remaining amount. A collateralized or secured loan protects the lender against a borrower's default, and at the same time enables the lender to offer lower interest rates and longer loan terms compared to uncollateralized loans.

Americans acquired nearly $565 billion in auto loans in 2016, and nearly $569 billion by the end of 2017. Over 18,000 dealerships sold more than 17 million cars and light trucks in United States in 2018. The auto loan industry has seen consistent gains with no signs of slowing over the past six years, and comprises a substantial source of commercial opportunities for dealerships and lenders.

As a result, automobile/vehicle dealerships, businesses that sells new or used vehicles at the retail level based on a dealership contract with an automaker or its sales subsidiary, design large, highly visible, and well-branded retail establishments, and purposefully locate them at well-trafficked locations to attract customer business. Dealerships display vehicles prominently, sometimes with their hoods open, and deploy balloons, flags, and other curiosity displays to attract curiosity, impulse, and walk-in customers. Dealerships also customarily use aggressive media marketing campaigns specifically designed to boost revenue and enhance customer interaction. These efforts work well.

Lenders face aggressive competition to secure loans from not only dealerships but also directly from borrowers. As a result, lenders routinely network with dealerships to gain dealership business. Lender-dealer networking is, however, costly and time-consuming and is known to yield unpredictable and inconsistent results. While lenders also utilize well-branded brick-and-mortar stores and expensive media marketing campaigns to draw customer business, they do not draw curiosity, impulse, or walk-in customer traffic like product retail establishments. In fact, lenders rarely directly originate customers in the field of auto loans. While consumers should research the vehicle they want to buy, its features, capabilities, reliability, and invoice price, rarely do consumers investigate lending institutions and loan products.

Consumers generally dislike the process of purchasing a vehicle. Most consumers are afraid of getting ripped off, do not like being treated condescendingly, do not want to be pressured in to making a purchase, dislike the negotiating process, are afraid being taken advantage of by the salesperson, and find the financing process, i.e. the loan application process, confusing and time-consuming. While arranging direct financing with a lender is desirable for some and routinely recommended, choosing the right lender can be difficult and time consuming. Also, terms for indirect financing have become increasingly competitive with direct financing options, which is why most consumers choose indirect financing. However, most dealership sales involving indirect financing often take at least three hours to complete, not including product delivery. At best, most customers are engaged about an hour, and then languish at the dealership for at least another two or three hours for completion of the financing process. The inherently prolonged sales process is frustrating not only for customers, but also for the dealerships because it inherently reduces productivity, limits the number of commercial opportunities for the dealership, namely, daily vehicle sales, and reduces customer satisfaction. The dealership financing process also, inherently or by design, does not provide customers with a broad range of diverse lenders and loan terms from which to choose, which limits consumer choice and leverage in addition to competition and commercial opportunities among diverse lenders.

In addition to vehicles, boats, recreational vehicles, motor homes, and the like are also expensive durable goods sold by dealerships and that most consumers also customarily purchase in the same way as vehicles, by collateralized or secured financing, namely, by borrowing the money from a lender to pay for the product pledged as collateral and then paying off the lender in installments. The issues described above facing sellers and lenders in the field of automobile/vehicle also face sellers and lenders in the fields of other durable goods, such as boats, recreational vehicles, motor homes, and real estate, all of which are customarily financed via secured or collateralized loans.

Unsecured loans are the reverse of secured loans. They include credit cards, student loans, or personal or signature loans. An asset does not guarantee an unsecured loan, and a lender is not authorized to seize property as payment for the loan in the event of default. Typically, a borrower should have a good credit history and income to obtain an unsecured loan. Loan amounts may be smaller since the lender does not have collateral to seize if the borrower defaults on the loan payments. Like secured loans, traditional application processes for obtaining unsecured loans can be equally cumbersome and time-consuming.

### SUMMARY OF THE INVENTION

Given the need for product sellers and lenders to increase revenue, increased competition among sellers and lenders, the need for sellers to provide customer satisfaction, the inherent need for consumer protection and consumer choice in commerce, and the need to improve and hasten the loan application process, whether for secured loans or unsecured loans, there is a substantial and ongoing need in the art to simplify and shorten the loan application and underwriting process to improve productivity, promote consumer choice amongst diverse loan products from diverse lenders, promote competition amongst diverse lenders without the need for reliance on conventional lender advertising and networking, improve commercial opportunities for lenders and borrower, promote honesty and transparency in lending, and provide consumers with more control over the financing process, all of which and others are solved by the illustrative embodiments of the invention disclosed throughout this specification.

According to the principle of the invention, an electronic loan underwriting system includes a computer warehouse serving a webpage and containing loan stores each including lending criteria and loan products of a lender, and a processor coupled to the computer warehouse and the webpage and programmed to receive from a web browser of a computer user loan application information about a borrower applying for a loan and for each loan store as the loan application information is being received by the processor both automatically a) compare the loan application information to the lending criteria and b) selectively post the loan products to the webpage on-the-go in real-time upon the loan application information corresponding to the lending criteria. The processor is additionally programmed to receive from the web browser of the computer user a signal indicating activation of a loan select control of the webpage and associated with a selected loan product posted to the website, automatically link the selected loan product to an external link of the webpage, and receive from the web browser of the computer user a signal indicating activation of the external link constituting an acceptance by the borrower of the selected loan product. The loan stores are different from one another. The lending criteria include creditworthiness factors that bear on an extent to which the borrower is considered suitable to receive credit. The loan products each include a loan amount, a term, and an interest rate. The loan application information includes an identification of the borrower, and creditworthiness data about the borrower. In a particular embodiment, the loan is to purchase a product for sale by a seller and pledged by the borrower as collateral for the loan via the webpage.

According to the principle of the invention, an electronic loan underwriting system includes a computer warehouse serving a webpage and containing loan stores each including lending criteria and loan products of a lender, a processor coupled to the computer warehouse and the webpage, and a computer readable storage medium that is not a signal storing computer executable instructions that when executed by the processor cause the processor to effectuate operations including receiving from a web browser of a computer user loan application information about a borrower applying for a loan and for each loan store as the loan application information is being received by the processor both automatically a) comparing the loan application information to the lending criteria and b) selectively posting the loan products to the webpage on-the-go in real-time upon the loan application information corresponding to the lending criteria. The operations additionally include receiving from the web browser of the computer user a signal indicating activation of a loan select control of the webpage and associated with a selected loan product posted to the website, automatically linking the selected loan product to an external link of the webpage, and receiving from the web browser of the computer user a signal indicating activation of the external link constituting an acceptance by the borrower of the selected loan product. The loan stores are different from one another. The lending criteria include creditworthiness factors that bear on an extent to which the borrower is considered suitable to receive credit. The loan products each include a loan amount, a term, and an interest rate. The loan application information includes an identification of the borrower, and creditworthiness data about the borrower. In a particular embodiment, the loan is to purchase a product for sale by a seller and pledged by the borrower as collateral for the loan via the webpage.

According to the principle of the invention, an electronic loan underwriting method includes establishing a computer warehouse serving a webpage and containing loan stores each including products and lending criteria of a lender, and a processor coupled to the computer warehouse and the webpage, and the processor receiving from a web browser of a computer user loan application information about a borrower applying for a loan and for each loan store as the loan application information is being received by the processor both automatically a) comparing the loan application information to the lending criteria and b) selectively posting the loan products to the webpage on-the-go in real-time upon the loan application information corresponding to the lending criteria. The operations additionally include receiving from the web browser of the computer user a signal indicating activation of a loan select control of the webpage and associated with a selected loan product posted to the posting section, automatically linking the selected loan product to an external link of the webpage, and receiving from the web browser of the computer user a signal indicating activation of the external link constituting an acceptance by the borrower of the selected loan product. The loan stores are different from one another. The lending criteria include creditworthiness factors that bear on an extent to which the borrower is considered suitable to receive credit. The loan products each include a loan amount, a term, and an interest rate. The loan application information includes, an identification of the borrower, and creditworthiness data about the borrower. In a particular embodiment, the loan is to purchase a product for sale by a seller and pledged by the borrower as collateral for the loan via the webpage.

### BRIEF DESCRIPTION OF THE DRAWINGS

Specific objects and advantages of the invention will become readily apparent to those skilled in the art from the following detailed description of illustrative embodiments thereof, taken in conjunction with the drawings in which:

FIG. 1 depicts a hardware and software architecture implementing the present invention;

FIG. 2 is a highly generalized screen capture of a loan content provider web site;

FIGS. 3-8 are loan underwriting webpage screen captures of the loan content provider website of FIG. 2; and

FIGS. 9-33 are loan application webpage screen captures of the loan content provider website of FIG. 2.

### DETAILED DESCRIPTION

Electronic loan underwriting systems and methods for automatically underwriting loan application information from, and automatically posting loan products of a loan content provider to, webpages on-the-go and in real-time upon entry of loan application information to the loan content provider via the webpages for expanding lending opportunities for lenders and borrowing opportunities for borrowers at the webpages are disclosed. The loan products posted to the webpages serve the commercial purposes of improving the speed and efficiency of the loan application process, creating a competitive online environment for lenders to directly compete for loan business during loan application processes and creating interest by the prospective borrowers visiting the webpages in loan products of the various lenders, for providing the lenders with the commercial opportunity to service consumer loans and for providing the borrowers visiting the webpages with the commercial opportunity of securing loan products having favorable terms.

In general, an automatic, electronic, on-the-go, and real-time loan underwriting system includes a computer warehouse serving a webpage and containing loan stores each including lending criteria and loan products of a lender, and a processor coupled to the computer warehouse and the webpage. The processor is programmed to receive from a web browser of a computer user loan application information about a borrower via the webpage and for each said loan store as the loan application information is being received by the processor both automatically compare the loan application information to the lending criteria and selectively post loan products to the webpage on-the-go in real-time upon the loan application information corresponding to the lending criteria. The processor in communication with the computer warehouse and the webpage is configured to enable a borrower to become qualified for loans and offered qualifying loan products at the webpage on-the-go and in real time in only the time used to enter loan application to the processor via the webpage by the computer user. The processor is additionally programmed to receive from the web browser of the computer user a signal indicating activation of a loan select control of the webpage and associated with a selected loan product posted to the website, automatically link the selected loan product to an external link of the webpage, and receive from the web browser of the computer user a signal indicating activation of the external link constituting an acceptance by the borrower of the selected loan product. The loan stores are different from one another. The lending criteria include loan amount and creditworthiness factors. The loan products each include a loan amount, a term, and an interest rate. The loan application information includes an identification of the borrower, and creditworthiness data about the borrower. The processor in communication with the computer warehouse and the webpage is configured to enable a borrower to become qualified for a loan and offered qualifying loan products at the webpage on-the-go and in real time in only the time used to enter loan application to the processor via the webpage by the computer user.

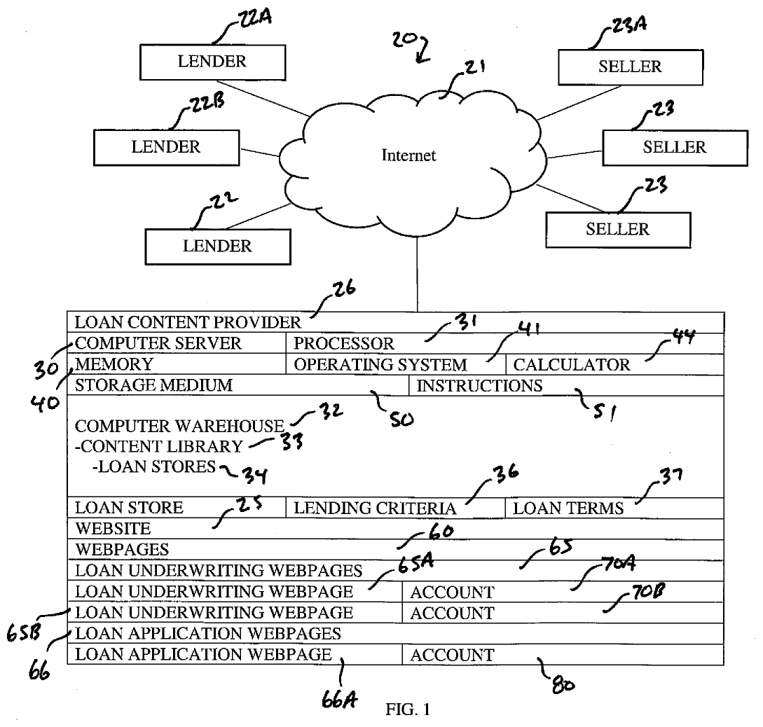

Turning now to the drawings, in which like reference characters indicate corresponding elements throughout the several views, attention is first directed to FIG. 1 illustrating system 20 including user computers 22 and user computers 23 electrically connected to a website 25 of provider 26 via Internet 21, an electronic network. FIG. 1 illustrates by way of example three user computers 22 and three user computers 23. Any number user computers 22 and user computers 23 can be connected to website 25 via Internet 21 in the use of the systems and methods herein disclosed. Website 25 is a group of webpages 60, including loan underwriting webpages 65, and loan application webpages 66. Provider 26 additionally includes computer server 30 including at least one processor 31 electronically and operatively coupled to a computer warehouse 32, a digital computer database, housing a content library 33 of loan stores 34, webpages 65, webpages 66, memory 40 that maintains a standard operating system 41 and a standard loan calculator 44, and a storage medium or memory 50. Each loan store 34 includes lending criteria 36 and loan products 37 of a lender. Loan stores 34 are different from one another and each relate to a lender, and the lenders of loan stores 34 are diverse, being different from one another. The lending criteria 36 of each loan store 23 include a suite of creditworthiness factors, such as income, monthly mortgage payment, and credit score factors in an illustrative embodiment, that bear on the extent to which a borrower is considered suitable to receive credit of a predetermined amount also considered to be part of the lending criteria 36. The loan products 37 each include loan terms, the conditions and requirements to be included in a loan agreement. The loan terms of each of the loan products 37 include at least a loan amount, a term, i.e. a duration of the loan, and an interest rate, the proportion of an amount loaned which a lender charges to the borrower to service the loan.

Processor 31 in communication with computer warehouse 32 of loan stores 34 and loan application webpages 66 is configured to enable borrowers to become qualified for loans and offered qualifying loan products at loan application webpages 66 on-the-go and in real time in only the time used to enter loan application to processor 31 via the loan application webpages 66 by computer users using user computers 23 in communication with the loan application webpages 66 via Internet 21. This is the case with each electronic loan underwriting embodiment disclosed throughout this specification.

Storage medium or memory 50 includes executable instructions 51 stored thereon that when executed by processor 31 in response to inputs from the user computers interacting with provider 26 via the website 25 webpages cause processor 31 to automatically effectuate the described dynamic loan underwriting and loan product posting operations of provider 26 on-the-go in real-time, meaning actively at the actual time during which the process takes place. Instructions 51 program processor 31 to automatically effectuate its described operations of provider 26 disclosed herein. Medium 50 can take on a variety of forms. For instance, medium 50 may take the form of program code (i.e., instructions 51) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, computer-readable storage medium 50 is non-transitory, is not a signal, is not a transient signal, and is not a propagating signal. Medium 50 described herein is an article of manufacture. The hardware of system 20 operates under the control of operating system 41 maintained by memory 40 enabling processor 31 to execute instructions 51 to effectuate the on-the-go, real-time operations of system 20 described with particularity in this disclosure.

Provider 26 is an online loan underwriter and loan content provider. More specifically, loan content provider 26 is an online platform to house loan stores 34, each including lending criteria 36 and loan products 37 of a lender from a loan underwriting webpage 65 of website 25 allocated to the lender, receive loan application information from loan application webpages 66 via user computers 23, automatically compare the loan application information to the lending criteria 36 of the loan stores 34, and automatically and selectively post loan products 37 of one or more of the loan stores 34 to the loan application webpages 32 on-the-go and in real-time upon the loan application information corresponding to the lending criteria 36 one or more of the loan stores 34. The party associated with each user computer 22 is a business user, a lender or creditor, such as a bank, a credit union, or other financial institution, for receiving, lending, exchanging, and safeguarding money, and issuing notes and, in most cases, transacting other financial business. Each user computer 22 can be referred to as a lender user computer.

The party associated with each user computer 23 is also a business user, in this example a seller that sells new or used products at the retail level, sufficiently expensive products, like vehicles, boats, motor homes, recreational vehicles, real estate, and the like, that most consumers customarily purchase from sellers, especially dealerships, by financing, by borrowing the money from a lender to pay for the product and then paying off the lender in installments. Each user computer 23 may be referred to as a seller user computer. Accordingly, various embodiments of the invention herein specifically described are discussed in connection with an application/financing process for a loan to purchase a product for sale by a seller and pledged by the borrower as collateral for the loan.

Each participating lender has a lender account, accessible via a respective one of user computers 22, with loan content provider 26, and is allocated a corresponding loan underwriting webpage 65 of website 25 as part of this lender account. Each participating seller has a seller account, accessible via a respective one of user computers 23, with loan content provider 26, and is allocated a corresponding loan application webpage 6 of website 25 as part of this seller account. Loan content provider 26 serves the webpages 65 and 66.

For ease of the ensuing discussion, the invention is discussed with two lender user computers, user computer 22A of a first lender/creditor business user, ABC Bank in this example, and user computer 22B of a different lender/creditor business user, 123 Bank in this example, and one user computer 23A of a seller business user, XYZ Dealership in this example, each connected to website 25 via Internet 21. The details of system 20 described below in conjunction with user computers 22A and 22B are identical and are the same for each user computer 22 and associated lender business user. The details of system 20 described below in conjunction with user computer 23A are likewise the same for each user computer 23 and associated seller business user.

The first lender business user, or simply the first lender user, ABC Bank in this example, the computer user of user computer 22A, has a loan underwriting account 70A with content provider 26. Loan underwriting account 70A, accessible via user computer 22A, is allocated loan underwriting webpage 65A, a lender user webpage of website 25. Reference numeral 65A denotes the term “loan underwriting webpage” of website 25, with the understanding that the term “loan underwriting webpage” associated with reference numeral 65A is used as a matter of convention and can be a single loan underwriting webpage of website 25 or a plurality of loan underwriting webpages of website 25. Access to lender user webpage 65A by the first lender user from user computer 22A is username/password protected in accordance with known techniques. Like all lender user webpages 65, lender user webpage 65A is a content webpage of loan stores, loan underwriting content of the first lender user, namely, lending criteria and loan products of the first lender user, ABC Bank in this example, according to the invention.

The seller business user, or simply the seller user, XYZ Dealership in this example, the computer user of user computer 23A, has a loan application account 80 with content provider 26. Loan application account 80, accessible via user computer 23A, is allocated loan application webpage 66A, a seller user webpage of website 25. Reference numeral 66A denotes the term “loan application webpage” of website 25, with the understanding that the term “loan application webpage” associated with reference numeral 66A is used as a matter of convention and can be a single loan application webpage of website 25 or a plurality of loan application webpages of website 25. Access to loan application webpage 66A by the seller user from user computer 23A is username/password protected in accordance with known techniques. Like all loan application webpages 66, loan application webpage 66A is an information/data input webpage, a webpage used to enter loan application content of a borrower wishing to purchase a product from the seller user, the loan application content being an identification of the product, an identification of the borrower, and creditworthiness data about the borrower in an illustrative embodiment, in addition to one to which provider 26 posts loan products from loan stores 34 of computer warehouse 32.

Loan underwriting account 70A of the first lender user is a user profile of the first lender user established by and accessed through website 25 from user computer 22A. Loan underwriting account 70A is established through website 25 from user computer 22A conventionally by filling out and submitting an online signup form or user profile through website 25. The online signup form or user profile accessed through website 25 includes standard graphical control elements, text fields and the like, used by the first lender user from user computer 22A to enter the first lender user's information (e.g., name, address, email address(es), phone number(s), etc.), chosen login credentials (e.g., username and password) to access loan underwriting account 70A and the loan underwriting webpage 65A allocated to content posting account 70A. From user computer 22A, the first lender user, ABC Bank in this example, can access website 25 via Internet 21 in FIG. 1 through an Internet address (i.e., a uniform recourse locator or “URL”), and can log into its loan underwriting account 70A. The first lender user can access website 25 via its designated web address from user computer 22A, and present the established login credentials at a login screen to access the loan underwriting webpage 65A allocated to loan underwriting account 70A.

FIGS. 3-5 are examples of screen captures of webpage 65A of loan underwriting account 70A. FIG. 3 is an example of a “home” page of webpage 65A. The lender is taken directly to the home page in FIG. 3 upon logging into loan underwriting account 70A from user computer 22A, or by logging into loan underwriting account 70A from user computer 22A and navigating to the home page. The home page in FIG. 3 can include graphical user interfaces, icons, buttons, and visual indicators, one or more texted-based or menu interfaces, and internal links, including internal site links, and external links associated with the graphical user interfaces. Internal and external links are types of hyperlinks. Links are “external” or “internal” depending on their target. A link to a page outside of webpage 65A of website 25 is external, whereas a link that points at another section or page of webpage 65A of website 25 is internal.

After the first lender user logs into the loan underwriting account 70A, webpage 65A, represented in this example by the various screen captures in FIGS. 3-5, can be selectively displayed on user computer 22A in response to signals received by processor 31 of computer server 30 from user computer 22A. Processor 31 of computer server 30 is programmed to automatically carry out specific functions governed by instructions 51 maintained by storage medium 50 in response to signals it receives from a web browser of user computer 22A according to the discussion below. Signals from user computer 22A to processor 31 of computer server 30 are initiated conventionally, such as with a mouse, keyboard, or other input device of user computer 22A.

The home page of webpage 65A in FIG. 3 is a “storefront” webpage of loan stores 34 of loan underwriting account 70A including, in this example loan stores 34A, 34B, 34C, and 34D. The displayed loan stores 34A, 34B, 34C, and 34D define different loan ranges as shown, chosen by the first lender user, and are each an internal link that when clicked takes the lender user to the corresponding internal loan store webpage of website 25. In this example, loan store 34A defines a $10,000.00-$19,999.00 loan range, loan store 34B defines a $20,000.00-$29,000.00 loan range, loan store 34C defines a $30,000.00-$39,000.00 loan range, and loan store 34D defines a $40,000.00-$49,999.00 loan range. The loan stores of the designated loan ranges categorize chosen loan ranges, and each include corresponding lending criteria 36 and loan products 37 chosen by the first lender user related to secured or collateralized loans within the applicable loan range. The loan ranges in FIG. 3 are shown simply by way of examples. The loan ranges can vary, and can be different from the displayed examples, and any number of loan ranges may be chosen by the first lender user and displayed at the storefront webpage shown by screen capture 90 in FIG. 3, according to the invention.

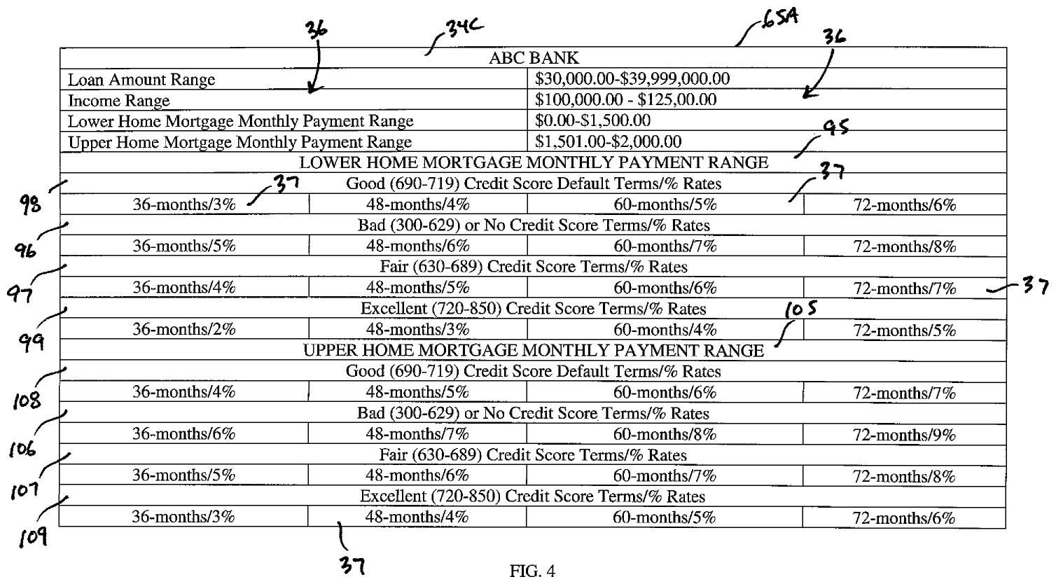

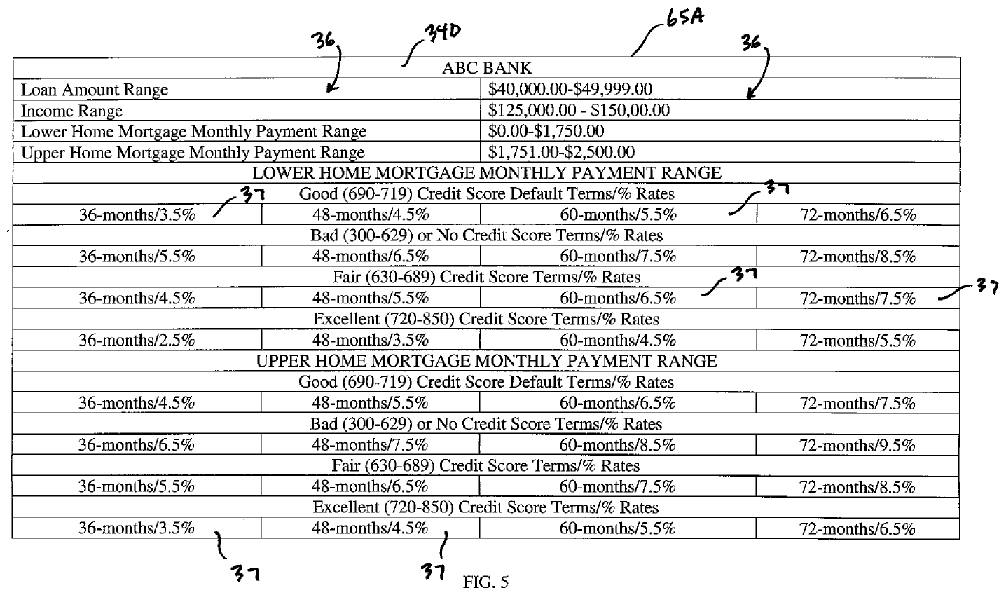

Loan stores 34A, 34B, 34C, and 34D each relate to an internal webpage of website 25, and are each identically accessed from the storefront webpage. To access the loan store webpage of loan store 34C, for example, from the storefront webpage in FIG. 3 the lender user clicks on loan store 34C, an internal link, which brings up the loan store 34C webpage 65A in FIG. 4, including loan underwriting content, namely, lending criteria 36 and loan products 37 of loan store 34C chosen by the first lender user and related specifically to the corresponding $30,000.00-$39,999.00 loan range. This process is the same for each of the remaining loan stores 34A, 34B, and 34D of loan underwriting account 70A, according to the invention.

The loan store 34C webpage 65A in FIG. 4, like all loan store webpages, is an internal content webpage of loan underwriting webpage 65A associated with account 70A that houses loan underwriting content, according to the invention. In this example, the loan store 34C webpage in FIG. 4 is a text-based user interface webpage document or form including data entry points containing required information for lending criteria 36 and loan products 37. The loan store 34C webpage can include other forms of data or information input user interfaces, such as one or more interfaces or the like. In this example, the lending criteria 36 include creditworthiness factors that bear on an extent to which the borrower is considered suitable to receive credit within a given loan amount range, $30,000.00-$39,000.00 in this example, including an income range, $100,000.00-$125,00.00, a lower home mortgage monthly payment range, $0.00-$1,500.00 in this example, an upper home mortgage monthly payment range, $1,501.00-$2,000.00, and credit score factors. These lending criteria 36, input into data entry points of the loan store 34C webpage by the first lender user using user computer 22A, are chosen by the first lender user and can be customized and modified as needed by the first lender user. The loan products 37 each include loan terms, including a term, i.e. a duration of a loan, and a percentage or interest rate, i.e. the finance charge representing the cost of credit repaid over time, related in this example to the $30,000.00-$39,999.00 loan amount range. The given loan range forms a part of the loan terms for each of the loan products.

The terms of the respective loan products 37 are, for example, 36-months, 48-months, 60-months, and 72-months, each of which of which is associated with a chosen percentage or interest rate. The loan products 37 are defined under numerically-defined “Bad”, “Fair”, “Good”, and “Excellent” credit ratings or factors both under the “LOWER HOME MORTGAGE MONTHLY PAYMENT RANGE” denoted at 95, and the “UPPER HOME MORTGAGE MONTHLY PAYMENT RANGE” denoted at 105. The “Bad”, “Fair”, “Good”, and “Excellent” credit factors are known credit factors are based on conventional and commonly-used credit scores.

A credit score is a numerical expression based on a level analysis of a person's credit files, to represent the creditworthiness of an individual. A credit score is primarily based on a credit report, information typically sourced from credit bureaus. Lenders use credit scores to evaluate the potential risk posed by lending money to consumers and to mitigate losses due to bad debt. Lenders use credit scores to determine who qualifies for a loan, at what interest, and what credit limits. Lenders also use credit scores to determine which customers are likely to bring in the most revenue. The use of credit or identity scoring prior to authorizing access or granting credit is an implementation of a trusted system. A known standard credit score schedule, which is used herein by way of example, includes 300-629 for “Bad” credit, 630-689 for “Fair” credit, 690-719 for “Good” credit, and 720-850 for “Excellent” credit.

By way of illustration, under the “LOWER HOME MORTGAGE MONTHLY PAYMENT RANGE” heading denoted at 95 in FIG. 4, which denotes the lower home mortgage monthly payment range of $0.00-$1,500.00 according to lending criteria 36, the loan products 37 are 36-months/5%, 48-months/6%, 60-months/7%, and 72-months/8% under the “Bad (300-629) or No Credit Score Terms/% Rates” denoted at 96, are 36-months/4%, 48-months/5%, 60-months/6%, and 72-months/7% under the “Fair (630-689) Credit Score Terms/% Rates” denoted at 97, are 36-months/3%, 48-months/4%, 60-months/5%, and 72-months/6% under the “Good (690-719) Credit Score Default Terms/% Rates” denoted at 98, and are 36-months/2%, 48-months/3%, 60-months/4%, and 72-months/5% under the “Excellent (720-850) Credit Score Terms/% Rates” denoted at 99. Also by way of illustration, under the “UPPER HOME MORTGAGE MONTHLY PAYMENT RANGE” heading denoted at 105 in FIG. 4, which denotes the upper home mortgage monthly payment range of $1,501.00-$2,000.00 according to lending criteria 36, the loan products 37 are 36-months/6%, 48-months/7%, 60-months/8%, and 72-months/9% under the “Bad (300-629) or No Credit Score Terms/% Rates” denoted at 106, are 36-months/5%, 48-months/6%, 60-months/7%, and 72-months/8% under the “Fair (630-689) Credit Score Terms/% Rates” denoted at 107, are 36-months/4%, 48-months/5%, 60-months/6%, and 72-months/7% under the “Good (690-719) Credit Score Default Terms/% Rates” denoted at 108, and are 36-months/3%, 48-months/4%, 60-months/5%, and 72-months/6% under the “Excellent (720-850) Credit Score Terms/% Rates” denoted at 109. The loan products 37, each being loan term and a percentage or interest rate combination chosen by the first lender user related to the given loan range, are each an underwritten or approved loan product when the loan application information about a borrower applying for a loan, for an amount within the designated loan amount range, $30,000.00-$39,999.00 in this example, to purchase a product for sale by a seller and pledged by the borrower as collateral for the loan selectively corresponds to correlating lending criteria 36, according to the invention. Account 70A can be selectively accessed via website 25 by the first lender user using user computer 22A, for selectively adding loan stores, amending loan stores, and removing/deleting loan stores, as desired.

The webpages of loan stores 34A, 34B, and 34D of ABC Bank are the same as loan store 34C webpage in form and structure, with the exception that values for the corresponding loan amount ranges, the lending criteria, and the loan products 37 chosen by the first lender user will vary. As a matter of example, FIG. 5 is a screen capture of loan store 34D webpage displaying chosen lending criteria 36 and loan products 37 of loan store 34D related to the $40,00.00-$49,999.00 loan range. Webpages for loan stores 34A and 34B are similarly arranged, according to the invention.

System 20 can include any number of loan underwriting webpages 65, each associated with a lender business user, and each associated with any chosen number of loan stores 34 each including its specific lending criteria and loan products chosen by the given lender business user, according to the invention. Loan underwriting webpages 65 of system 20 are, otherwise, the same in form and structure. Accordingly, the form and structure of loan underwriting webpage 65A applies equally to each loan underwriting webpage 65 of system 20.

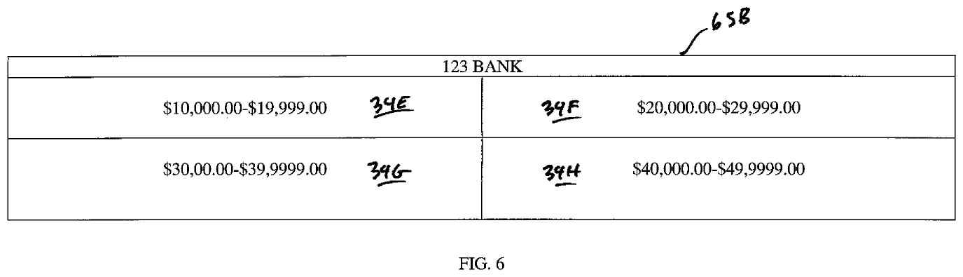

As indicated above, for ease of discussion system 20 in FIG. 1 includes two loan underwriting webpages 65, namely, the previously-described loan underwriting webpage 65A associated with account 70A of the first lender user, ABC Bank, and lender user computer 22A, and loan underwriting webpage 65B associated with account 70B of the second lender user, 123 Bank, and lender user computer 22B. FIGS. 6-8 are examples of screen captures of webpage 65B of loan underwriting account 70B associated with 123 Bank, the second lender user that is different from the first lender user, ABC Bank. Webpage 65B associated with account 70B will now be briefly discussed.

The home page of webpage 65B in FIG. 6 is the storefront webpage of loan stores 34 of loan underwriting account 70B. The loan stores 34 of account 70B include loan stores 34E, 34F, 34G, and 34H. The displayed loan stores 34E, 34F, 34G, and 34H define different loan ranges as clearly shown, chosen by the second lender user, and are each an internal link that when clicked takes the lender user to the corresponding internal loan store webpage of website 25. In this example, loan store 34E defines a $10,000.00-$19,999.00 loan range like loan store 34A, loan store 34F defines a $20,000.00-$29,000.00 loan range like loan store 34B, loan store 34G defines a $30,000.00-$39,000.00 loan range like loan store 34C, and loan store 34H defines a $40,000.00-$49,999.00 loan range like loan store 34D. The loan stores of the designated loan ranges include corresponding lending criteria and loan products, each including a term, i.e. a loan duration, and a percentage/interest rate, chosen by the second lender user for secured or collateralized loans within the various loan ranges. The loan ranges in FIG. 6 are shown simply by way of examples. The loan ranges can vary, and can be different from the displayed examples, and any number of loan ranges may be chosen by the second lender user and displayed at the storefront webpage shown in FIG. 6, according to the invention.

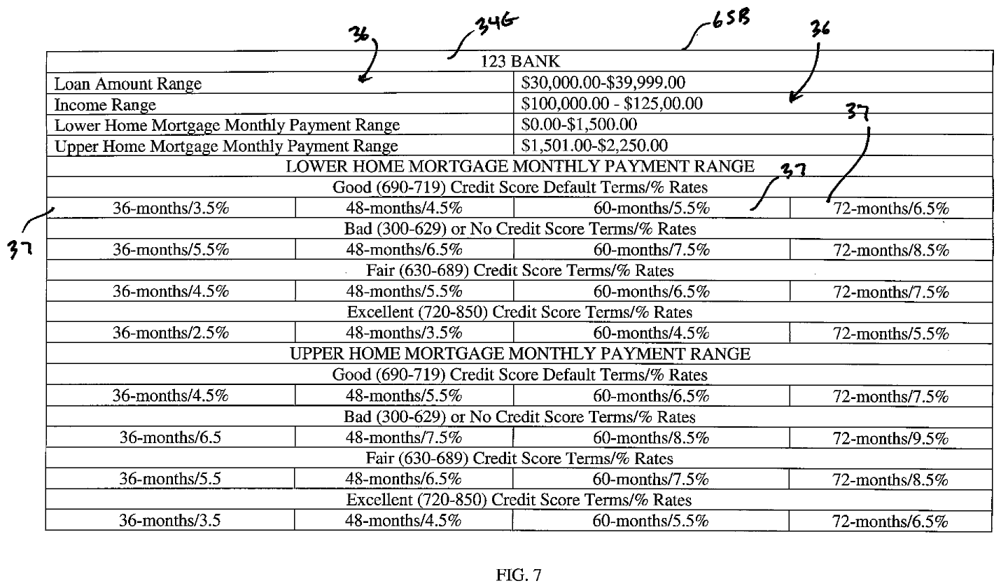

By way of example, FIG. 7 is a screen capture of loan store 34G webpage 65B, which incorporates loan underwriting content, namely, lending criteria 36 and loan products 37 of loan store 34G chosen by the second lender user and related specifically to the corresponding $30,000.00-$39,999.00 loan range. The lending criteria 36 include creditworthiness factors that bear on an extent to which the borrower is considered suitable to receive credit in a loan amount range, $30,000.00-$39,000.00 in this example, in which the creditworthiness factors include an income range, $100,000.00-$125,00.00 in this example, a lower home mortgage monthly payment range, $0.00-$1,500.00 in this example, and an upper home mortgage monthly payment range, $1,501.00-$2,250.00. These lending criteria 36 are chosen by the second lender user and can be customized and modified as needed by the second lender user. The loan products 37 each include loan terms including a term, i.e. a duration of a loan, and a percentage or interest rate, i.e. the finance charge representing the cost of credit repaid over time, related to the $30,000.00-$39,999.00 loan amount range in this example. The given loan range forms a part of the loan terms for each of the loan products.

The terms of the respective loan products 37 in FIG. 7 are, for example, 36-months, 48-months, 60-months, and 72-months, each of which of which is associated with a chosen percentage or interest rate. The loan products 37 of loan store 34G are defined under the previously-disclosed numerically-defined “Bad”, “Fair”, “Good”, and “Excellent” credit ratings or factors both under the “LOWER HOME MORTGAGE MONTHLY PAYMENT RANGE” denoted at 95, and the “UPPER HOME MORTGAGE MONTHLY PAYMENT RANGE” denoted at 105.

By way of illustration, under the “LOWER HOME MORTGAGE MONTHLY PAYMENT RANGE” heading denoted at 95 in FIG. 7, which denotes the lower home mortgage monthly payment range of $0.00-$1,500.00 according to lending criteria 36, the loan products 37 are 36-months/5.5%, 48-months/6.5%, 60-months/7.5%, and 72-months/8.5% under the “Bad (300-629) or No Credit Score Terms/% Rates” denoted at 96, are 36-months/4.5%, 48-months/5.5%, 60-months/6.5%, and 72-months/7.5% under the “Fair (630-689) Credit Score Terms/% Rates” denoted at 97, are 36-months/3.5%, 48-months/4.5%, 60-months/5.5%, and 72-months/6.5% under the “Good (690-719) Credit Score Default Terms/% Rates” denoted at 98, and are 36-months/2.5%, 48-months/3.5%, 60-months/4.5%, and 72-months/5.5% under the “Excellent (720-850) Credit Score Terms/% Rates” denoted at 99. Also by way of illustration, under the “UPPER HOME MORTGAGE MONTHLY PAYMENT RANGE” heading denoted at 105 in FIG. 7, which denotes the upper home mortgage monthly payment range of $1,501.00-$2,250.00 according to lending criteria 36, the loan products 37 are 36-months/6.5%, 48-months/7.5%, 60-months/8.5%, and 72-months/9.5% under the “Bad (300-629) or No Credit Score Terms/% Rates” denoted at 106, are 36-months/5.5%, 48-months/6.5%, 60-months/7.5%, and 72-months/8.5% under the “Fair (630-689) Credit Score Terms/% Rates” denoted at 107, are 36-months/4.5%, 48-months/5.5%, 60-months/6.5%, and 72-months/7.5% under the “Good (690-719) Credit Score Default Terms/% Rates” denoted at 108, and are 36-months/3.5%, 48-months/4.5%, 60-months/5.5%, and 72-months/6.5% under the “Excellent (720-850) Credit Score Terms/% Rates” denoted at 109. The loan products 37, each being loan term and a percentage or interest rate combination chosen by the second lender user related to the given loan range, are each an underwritten or approved loan product when the loan application information about a borrower applying for a loan, for an amount within the designated loan amount range, $30,000.00-$39,999.00 in this example, to purchase a product for sale by a seller and pledged by the borrower as collateral for the loan selectively corresponds to correlating lending criteria 36, according to the invention. Account 70B can be selectively accessed via website 25 by the second lender user using user computer 22A, for selectively adding loan stores, amending loan stores, and removing/deleting loan stores, as desired.

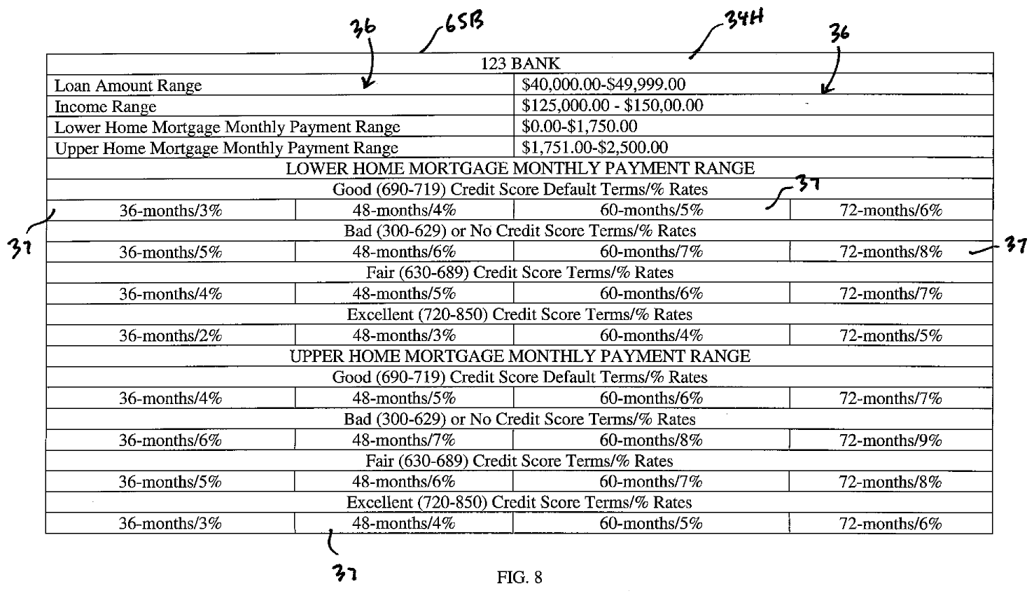

The webpages of loan stores 34E, 34F, and 34H of 123 Bank are the same as loan store 34G webpage in form and structure, with the exception that values for the corresponding loan amount ranges, the lending criteria, and the loan products 37 chosen by the second lender user and will vary. As a matter of example, FIG. 8 is a screen capture of loan store 34H webpage displaying chosen lending criteria 36 and loan products 37 of loan store 34H related to the $40,00.00-$49,999.00 loan range. Webpages for loan stores 34E and 34F are similarly arranged, according to the invention.

Loan underwriting webpages 65 are loan underwriting content webpages related to diverse lender users for establishing and maintaining loan stores 34 of diverse, third-party lenders. Loan stores 34 constitute content library 33 maintained by computer warehouse 32, according to the invention. Although the disclosed loan store webpages are text-based user interface webpages by way of example, the loan store webpages can be configured with other user interface formats without departing from the invention.

Referring to FIG. 1, loan application account 80 of the seller user, XYZ Dealership in this example, is a user profile of the seller user established by and accessed through website 25 from user computer 23A. Loan application account 80 is established through website 25 from user computer 23A conventionally by filling out and submitting an online signup form or user profile through website 25. The online signup form or user profile accessed through website 25 includes standard graphical control elements, text fields and the like, used by the seller user from user computer 23A to enter the seller user's information (e.g., name, address, email address(es), phone number(s), etc.), chosen login credentials (e.g., username and password) to access loan application account 80 and the loan application 66A allocated to loan application account 80. From user computer 23A, the seller user, XYZ Dealership in this example, can access website 25 via Internet 21 in FIG. 1 through an Internet address (i.e., a Uniform recourse locator or “URL”), and can log into its loan application account 80. The seller user can access website 25 via its designated web address from user computer 23A, and present the established login credentials at a login screen to access the loan application webpage 66A allocated to loan application account 80.

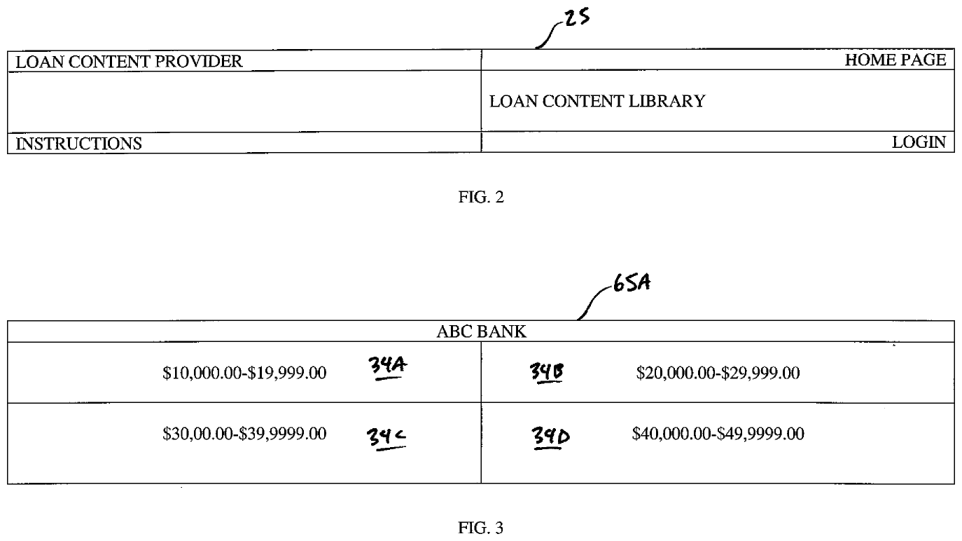

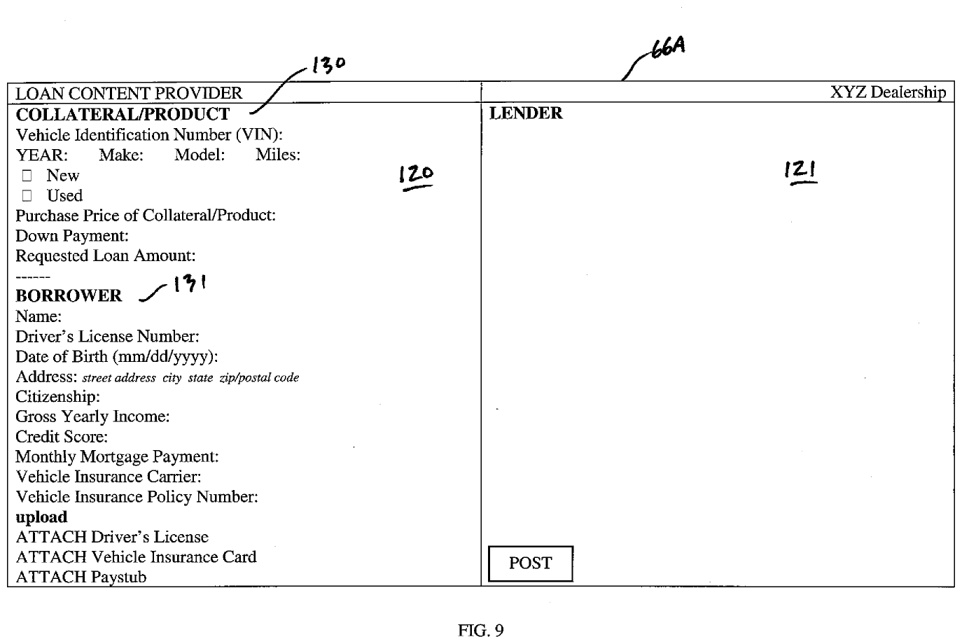

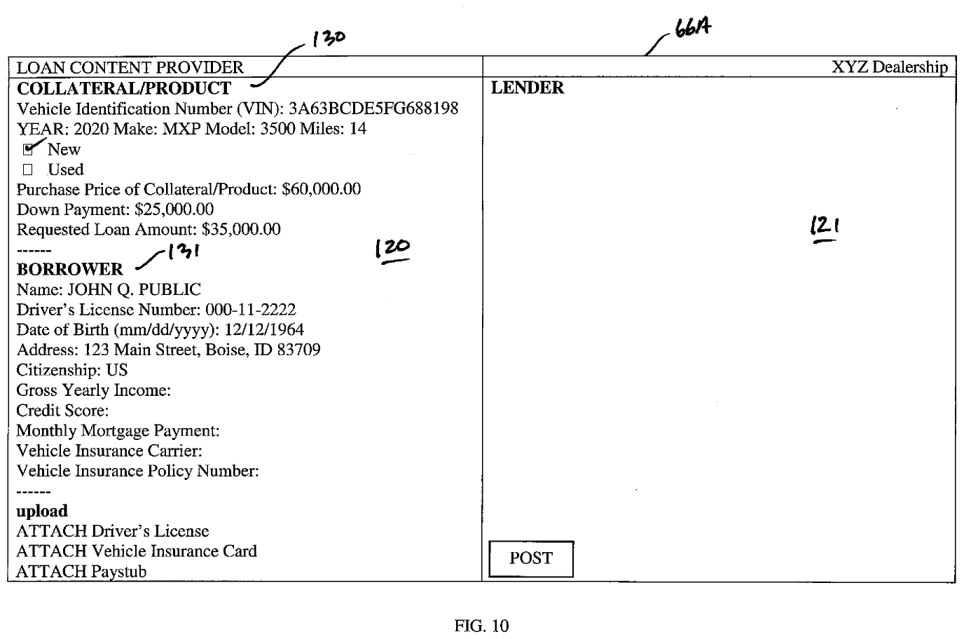

By way of illustration, FIGS. 9-33 are loan application webpage 66A screen captures of the loan content provider website 25 of FIG. 2 designed to illustrate automatic loan underwriting and loan product posting operations. The screen capture in FIG. 9 is an example of a loan application webpage of website 25, loan application webpage 66A. The computer user using user computer 23A is taken directly to the page in FIG. 9 upon logging into loan application account 80, or by logging into loan application account 80 from user computer 23A and navigating to the loan application webpage 66A. The page in FIG. 9 can include graphical user interfaces, icons, buttons, and visual indicators, one or more texted-based interfaces, menus, and internal links, including internal site links, and external links associated with the graphical user interfaces, as may be desired.

After the computer user logs into the loan application account 80, webpage 65A in FIG. 9 is selectively displayed on user computer 23A in response to signals received by processor 31 of computer server 30 from user computer 23A. Loan application webpage 66A in FIG. 9, like all loan application webpages, is a content webpage for the entry and housing of loan application information. The loan application information relates to the previously-described lending criteria 36 and loan products 37 of the various loan stores 34 of computer warehouse 32, and is about a borrower applying for a loan to purchase a product for sale by a seller and pledged by the borrower as collateral for the loan, such as an identification of a product to be purchased, an identification of the borrower, and creditworthiness data about the borrower related to lending criteria 36 of the various loan stores 34. Processor 31 of computer server 30 is programmed via instructions 51 maintained by storage medium 50 to automatically carry out specific functions in response to signals/information it receives from a web browser of user computer 23A while loan application information is being entered into webpage 66A by the seller business user using user computer 23A according to the discussion below. Signals from user computer 23A to processor 31 of computer server 30 are initiated conventionally, such as with a mouse, keyboard, or other input device of user computer 23A.

By way of example, loan application webpage 66A in FIG. 9 is a text-based user interface webpage document or form including data entry points for accepting designated loan application information, including information about the collateral, the product to be purchased, and information about the borrower and the borrower's creditworthiness. Webpage 66A includes two sections, an input section, denoted generally at 120, and an output or posting section, denoted generally at 121, both of which are in communication with processor 31 and thereby computer warehouse 32 of loan stores 34.

Input section 120 is configured to accept the loan application information input therein by the user using user computer 23A. Processor 31 is operatively coupled to receive the loan application information entered into input section 120 and automatically and selectively consult the loan criteria 36 of the loan stores 34 of computer warehouse 32 in response. Posting section 121 is configured to accept and display outputs from processor 31, posts of loan products 37 of loan stores 34 of computer warehouse 32 for a user visiting webpage 66A via user computer 23A.

Processor 31 in communication with input section 120 of webpage 66A is programmed to receive from a web browser of a computer user the loan application information from input section 120 of webpage 66A, automatically compare the loan application information to lending criteria 36 of the loan stores 34, retrieve any loan stores 34 including lending criteria 36 selectively corresponding/matching the received loan application information and for each corresponding/matching loan store 34 retrieve corresponding loan products 37 thereof matching or otherwise corresponding to the received loan application information, and post the retrieved loan products 37 to posting section 121 of webpage 66A, all on-the-go, the term “on-the-go” meaning as a process is being done, and in real-time, the term “real-time” meaning the actual time during which a process is taking place or an event is occurring, while processor 31 is performing its operations. This disclosure sets forth a particular order of entry of loan application information and automatic responses performed by processor 31 of provider 26 in response. It is to be understood that the order in which the loan application information is presented and entered can vary as desired consistent with the teachings presented herein.

Shown by way of example are two categories of loan application information in input section 120: a collateral/product category denoted at 130, and a borrower category denoted at 131. In this example, XYZ Dealership, the seller business user, is a vehicle dealership, the collateral to be purchased is a vehicle, a durable good, and the borrower, an individual, is customer of XYZ Dealership to purchase the vehicle.

Present under collateral category 130 and borrower category 131 are selected line items each associated with a data entry point. This arrangement is generally representative of a text-based user interface, which characterizes input section 120. As shown in FIG. 9, the line items of collateral category 130 include, by way of example, “Vehicle Identification Number (VIN)”, “YEAR”, “Make”, “Model”, and “Miles”, “New” and “Used”, each associated with a dialog box in this example, “Purchase Price of Collateral/Product”, “Down Payment”, and “Requested Loan Amount”. The embodiment of line items under collateral category 130 is an example of a suite of information sufficient to identify a vehicle, the cost of the vehicle, the down payment by the borrower and, of course, the loan amount requested by the borrower. The line items identifying the collateral can vary and may be tailored to relate to the chosen collateral at hand. The line items for borrower category 131 include “Name”, “Driver's License Number”, “Date of Birth (mm/dd/yyyy)”, “Address”, “Citizenship”, “Gross Yearly Income”, “Credit Score”, “Monthly Mortgage Payment”, “Vehicle Insurance Carrier”, and “Vehicle Insurance Policy Number”, followed by an upload section including “ATTACH Driver's License”, “ATTACH Vehicle Insurance Card”, and “ATTACH Paystub”. The line items under borrower category 131 are shown by way of an example of information sufficient to identify the borrower and his creditworthiness. Other line items can be included as may be desired, such as the borrower's social security number, a 3^{rd} party contact, employer name and address, etc.

By way of example, it is assumed in this example that a borrower is ready to purchase a vehicle from XYZ Dealership, that the borrower and XYZ Dealership have agreed to the vehicle the borrower intends to purchase and its purchase price. To initiate the underwriting/financing process, from webpage 66A in FIG. 9 the user using user computer 23A initially fills in webpage 66A in FIG. 10 and inputs collateral and borrower information in the respective collateral and borrower categories 130 and 131 of input section 120. The vehicle designated in FIG. 10 is fictitious, is presented by way of example, and does not represent any actual vehicle or vehicle brand. The designated borrower in FIG. 10 likewise is fictitious, is presented by way of example, and does not represent any actual person.

Upon entry into input section 120 of the requested loan amount of $35,000.00, information that corresponds the loan amount range of the lending criteria 36 of the loan stores 34, processor 31 in communication with input section 120 is responsive and automatically receives it, automatically compares it to the loan amount ranges of the loan stores 34 of computer warehouse 32, and automatically retrieves any loan store 34 having a loan amount range that encompasses, i.e. corresponds to, the requested loan amount of $35,000.00, all on-the-go and in real-time. In this example, loan stores 34C and 34G each include a loan amount range that encompasses the requested loan amount of $35,000.00. As a result, processor 31 automatically retrieves loan stores 34C and 34G in response to entry of the $35,000.00 requested loan amount in input section 120 of webpage 66A in FIG. 10.

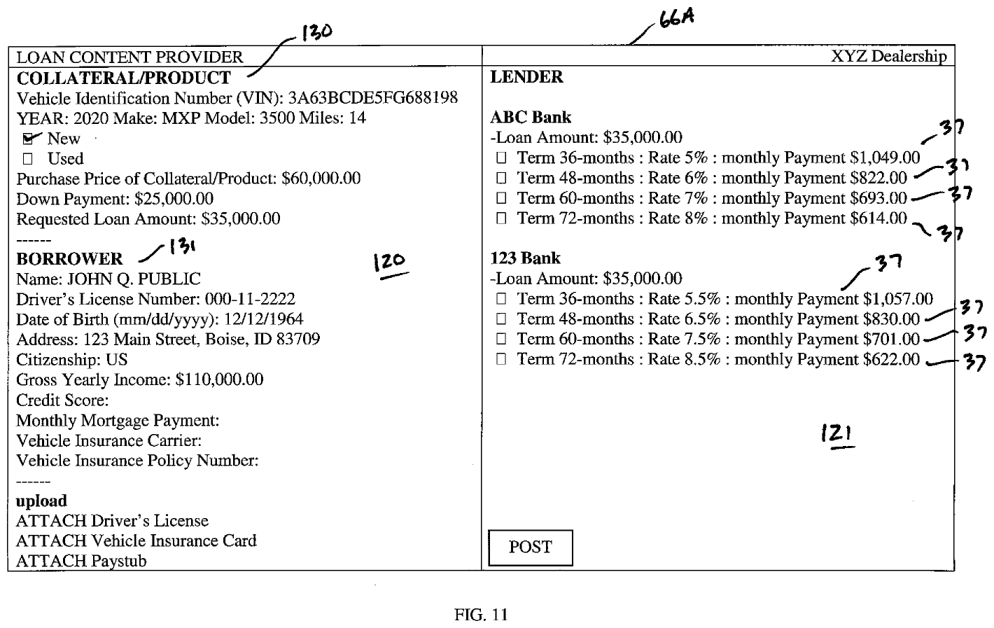

The user using user computer 23A then fills in the Gross Yearly Income of the borrower in FIG. 11, which is $110,000.00 in this example. Upon entry into input section 120 of the borrower's Gross Yearly income of $110,000.00, information that corresponds the income range of the lending criteria 36 of the retrieved loan stores 34C and 34G, processor 31 in communication with input section 120 is responsive and automatically receives it, automatically compares it to the income ranges of the retrieved loan stores 34C and 34G, and automatically retrieves loan products 37 from any of the retrieved loan stores 34C and 34G having an income range that encompasses, i.e. corresponds to, the $110,000.00 Gross Annual Income input into input section 120. In this example, loan stores 34C and 34G each include an income range of $100,000.00-$125,000.00 that encompasses the input $110,000.00 Gross Annual Income. As a result, processor 31 in communication with computer warehouse 32 and posting section 121 automatically retrieves loan products 37 from loan stores 34C and 34G and posts them to posting section 121 in FIG. 11 in response, all on-the-go and in real-time according to the invention.

Posted to posting section 121 in FIG. 11 are loan products 37 for ABC Bank, and loan products 37 for 123 Bank. By default, as a matter of example, processor 31 is programmed to initially retrieve the “Good” loan products 37 under the “LOWER HOME MORTGAGE MONTHLY PAYMENT RANGE” of the initially retrieved loan stores, loan stores 34C and 34G in this example, and post them to posting section 121 as shown in FIG. 11 for the user visiting webpage 66A. This is a chosen starting point in an illustrative embodiment. At the same time, loan calculator 44 automatically calculates the monthly payment for each of loan products 37, which processor 31 automatically includes in each posted loan product 37 as shown in FIG. 11. This happens each time a loan product 37 is posted to posting section 121 by processor 31. This way, the monthly payment for each loan product 37 is available for immediate reference by the user visiting webpage 66A. There are four loan products 37 under each of ABC Bank and 123 Bank corresponding to the 36-, 48-, 60-, and 72-month “Good” loan products 37 under the “LOWER HOME MORTGAGE MONTHLY PAYMENT RANGE” of the respective loan stores 34C and 34G. These ABC Bank and 123 Bank loan term postings posted to posting section 121 of webpage 66A are inherently competitive postings between the inherently diverse lenders, and provide the user visiting and interacting with website 66A using user computer 23A with immediate, on-the-go feedback in the nature of potential loan products of diverse lenders, ABC Bank and 123 Bank in this example.

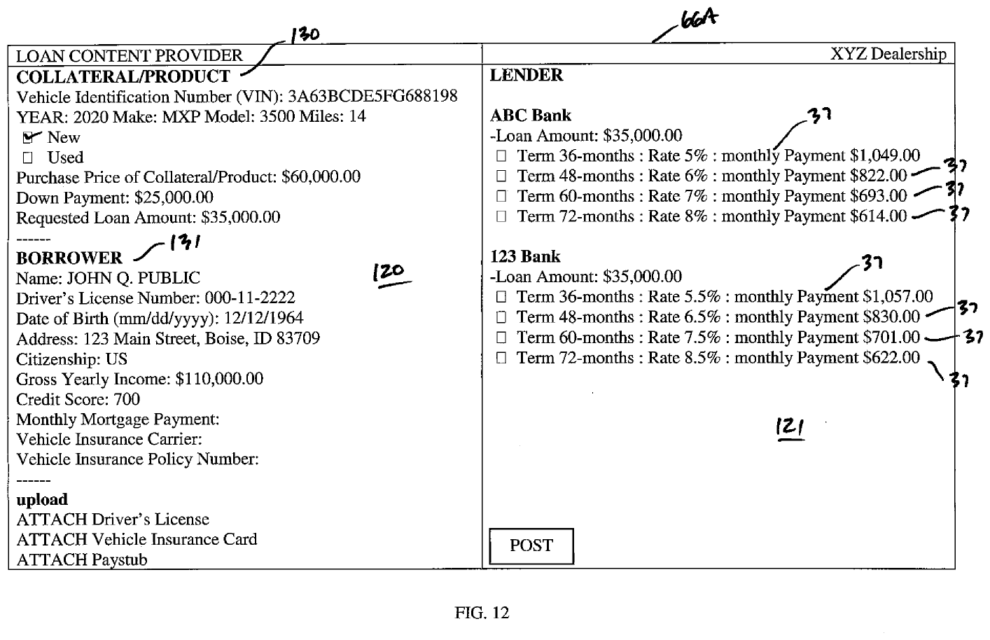

The user using user computer 23A then fills in the Credit Score, previously determined/known, of the borrower in FIG. 12, which is 700 in this example. Upon entry into input section 120 of the borrower's 700 Credit Score, information that corresponds the credit score factors of the lending criteria 36 of the retrieved loan stores 34C and 34G, processor 31 in communication with input section 120 is responsive and automatically receives it, automatically compares it to the credit score ranges of the retrieved loan stores 34C and 34G, and automatically retrieves loan products 37 under the “LOWER HOME MORTGAGE MONTHLY PAYMENT RANGE” from any of the retrieved loan stores 34C and 34G having a credit score range that encompasses, i.e. corresponds to, the 700 Credit Score input into input section 120. In this example, loan stores 34C and 34G each include a Good Credit Score range of 690-719 under the “LOWER HOME MORTGAGE MONTHLY PAYMENT RANGE” that encompasses the input 700 input Credit Score. Since by default processor 31 initially posted the “Good” loan products 37 under the “LOWER HOME MORTGAGE MONTHLY PAYMENT RANGE” of the retrieved loan stores, loan stores 34C and 34G in this example, processor 31 in communication with computer warehouse 32 and posting section 121 is responsive on-the-go and in real-time to entry into input section 120 of the 700 credit score and leaves the posts in posting section 121 of webpage 66A unchanged as shown in FIG. 12.

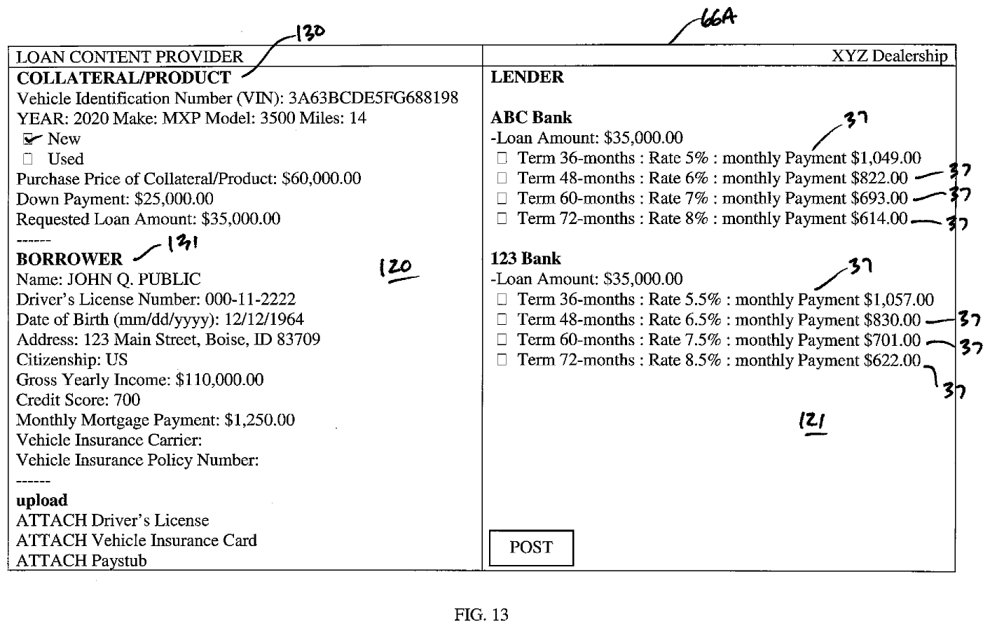

The user using user computer 23A then fills in the Monthly Mortgage Payment of the borrower in FIG. 13, which is $1,250.00 in this example. Upon entry into input section 120 of the borrower's $1,250.00 Monthly Mortgage Payment, information that corresponds the monthly mortgage payment ranges of the lending criteria 36 of the retrieved loan stores 34C and 34G, processor 31 in communication with input section 120 is responsive and automatically receives it, automatically compares it to the monthly mortgage payment ranges of the retrieved loan stores 34C and 34G, and automatically retrieves loan products 37 the from the retrieved loan stores 34C and 34G having a monthly mortgage payment range that encompasses, i.e., corresponds to, the $1,250.00 Monthly Mortgage Payment input into input section and having a credit score range that encompasses, i.e. corresponds to, the 700 Credit Score previously input into input section 120. In this example, loan stores 34C and 34G each include a Good Credit Score range of 690-719 under the “LOWER HOME MORTGAGE MONTHLY PAYMENT RANGE” that encompasses the input 700 Credit Score and a Lower Home Mortgage Monthly Payment Range that encompasses the input $1.250.00 Monthly Mortgage Payment. Since by default processor 31 initially posted the “Good” loan products 37 under the “LOWER HOME MORTGAGE MONTHLY PAYMENT RANGE” of the retrieved loan stores, loan stores 34C and 34G in this example, processor 31 in communication with computer warehouse 32 and posting section 121 is responsive on-the-go and in real-time to entry into input section 120 of the $1,250.00 Monthly Mortgage Payment and leaves the posts in posting section 121 of webpage 66A unchanged as shown in FIG. 13.

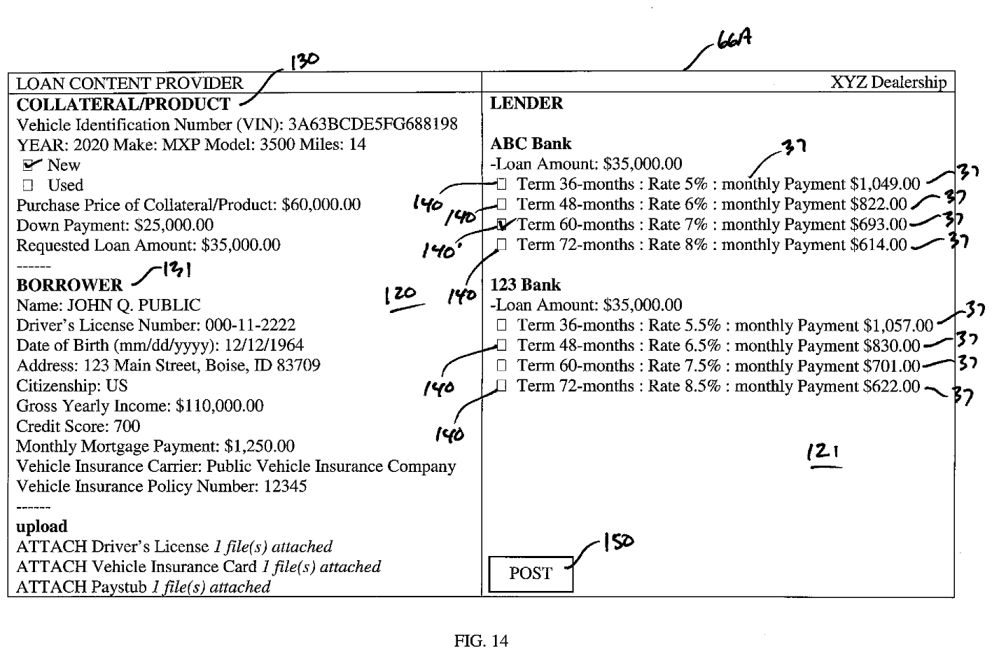

The user using user computer 23A then completes the form in FIG. 14 by filling in the remaining information, including the borrower's Insurance Carrier, Insurance Policy Number, and, as an option for verification purposes, and uploading to webpage 66A via conventional means the borrower's Driver's License, Insurance Card, and a Paystub. Upon completion of loan application, processor 31 in communication with input section 120 is responsive and receives the remaining information and uploaded documents and, in response, automatically activates a loan select control 140, a dialog box in this example, a graphical control element that prompts a response, next to each posted loan product 37 in posting section 121.

The ABC Bank and 123 Bank loan products 37 posted to posting section 121 of webpage 66A by the automatic underwriting process effectuated by processor 31 in response to entry of the loan application information entered into input section 120 are loan products for which the borrower qualifies, are inherently competitive postings between the inherently diverse lenders. Each posted loan product 37 serves a commercial purpose of promoting a user visiting webpage 66A from user computer 23A to engage in commerce with the lender business user related to the post, serves a commercial opportunity for the user visiting webpage 66A of securing a favorable loan for a borrower, and serves a commercial opportunity for the lender to secure and service a consumer loan. Upon the borrower electing a desired loan product amongst the various posted loan products 37, a loan product considered by the borrower to be the best or most favorable loan product amongst the posted loan products, the user using user computer 23A selects the loan select control 140 next to the borrower's elected loan product, loan select control 140′ next to the “Term 60-months: Rate 7%: monthly Payment $693.00” ABC Bank loan product in this example. On-the-go, real-time feedback in the nature of loan products competing with one another at posting section 121 is disclosed, in which each one of the loan products is a commercial opportunity for the lender, the borrower, and the seller to complete the sale quickly for improving productivity.

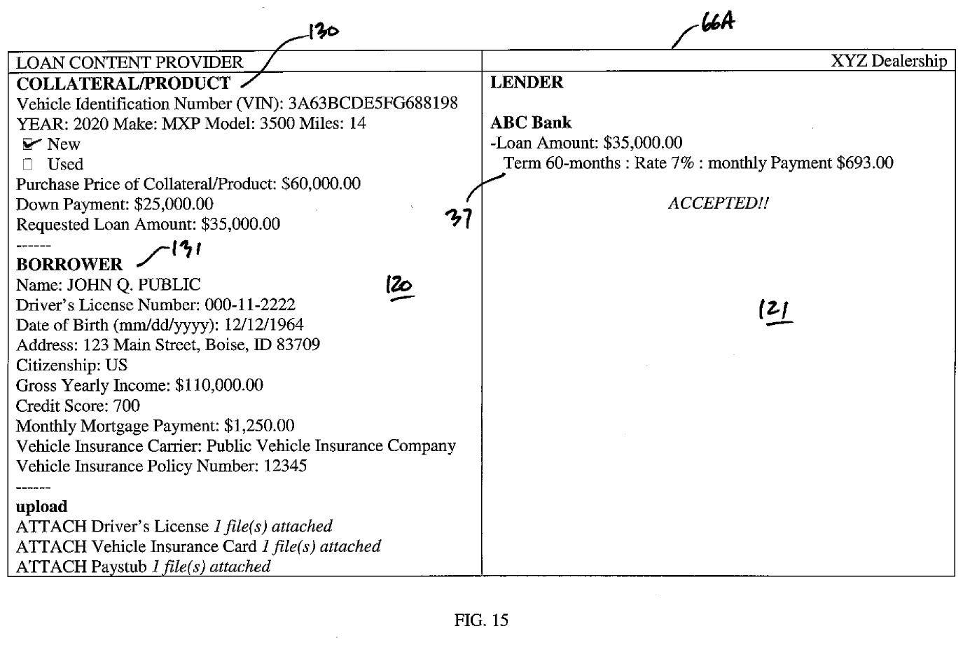

Processor 31 is additionally programmed via instructions 51 to automatically receive from the web browser of the computer user using user computer 23A a signal indicating activation of the selected webpage 66A loan select control 140 associated with selected loan terms posted to website 66A, loan select control 140′ next to the “Term 60-months: Rate 7%: monthly Payment $693.00” ABC Bank loan product in this example, automatically link the selected loan terms to external link 150 of posting section 121 of webpage 66A, and receive from the web browser of the computer user a signal indicating activation of external link 150 constituting an acceptance by the borrower of the selected loan terms posted to posting section 121 of website 66A, according to the invention. In response to processor 31 receiving the signal indicating activation of external posting link 150, processor 31 automatically overwrites all loan products from posting section 121 except for the selected loan product 37, and posts an acceptance message in posting section 121, “ACCEPTED!!” in this example, constituting an acceptance by the borrower and the lender of the loan product 37 posted to webpage 66A of website 25, shown in FIG. 15. The consumer loan is then finalized by loan document execution in the normal manner from the information in loan application webpage 65A and the product is delivered to the borrower, typically at the seller's retail location.

Those having regard for the art will readily appreciate that processor 31 in communication with computer warehouse 32 of loan stores 34 and loan application webpage 66A is configured to enable the borrower to become qualified for loans and offered qualifying loan products at loan application webpage 66A on-the-go and in real time in only the time, no more than about 1-3 minutes in this example, used to enter loan application to processor 31 via the loan application webpage 66 by the computer user using user computer 23A in communication with loan application webpage 66A via Internet 21, as is the case with each of the ensuing alternate electronic loan underwriting embodiments which will now be briefly discussed.

In the electronic loan underwriting process described in conjunction with FIGS. 10-14, the loan products 37 posted to posting section 121 did not change during the process. However, they may change dynamically by processor 31 during the loan application and loan underwriting process depending on the loan application information input into input section 120. A number of examples of this are discussed below.

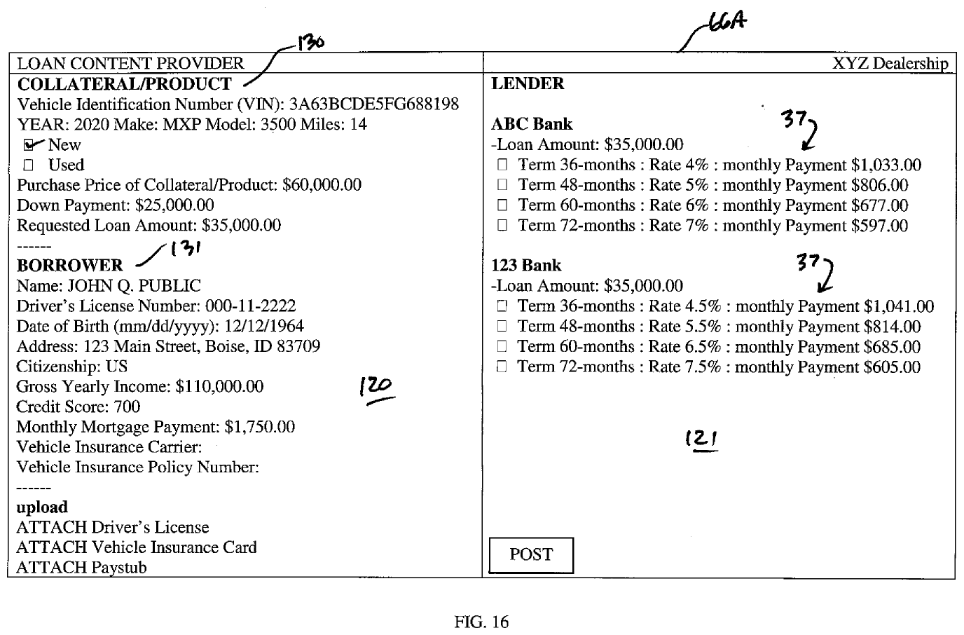

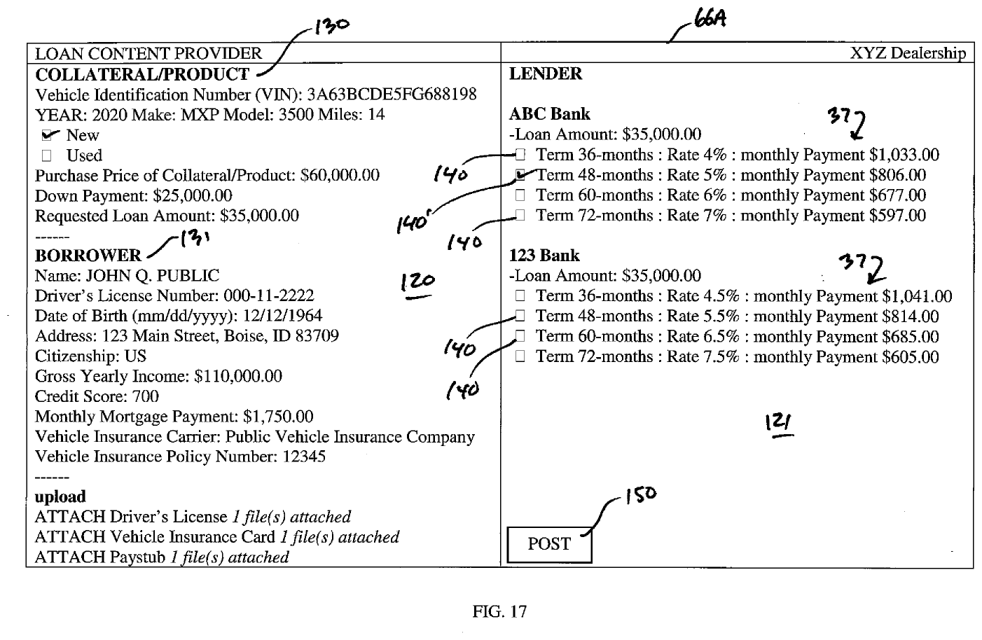

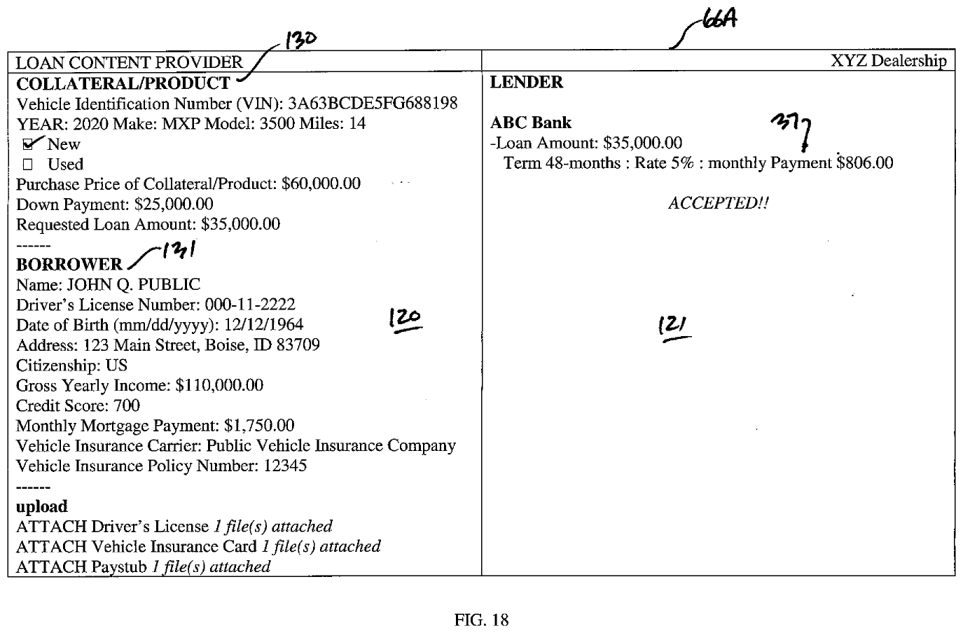

In one example, during the loan application entry process from webpage 66A in FIG. 12 in an alternate embodiment the user using user computer 23A fills in the Monthly Mortgage Payment of the borrower in FIG. 16 as $1,750.00 instead of $1,250.00. Upon entry into input section 120 of the borrower's $1,750.00 Monthly Mortgage Payment, information that corresponds the monthly mortgage payment ranges of the lending criteria 36 of the retrieved loan stores 34C and 34G, processor 31 in communication with input section 120 is responsive and automatically receives it, automatically compares it to the monthly mortgage payment ranges of the retrieved loan stores 34C and 34G, and automatically retrieves loan products 37 the from the retrieved loan stores 34C and 34G having a monthly mortgage payment range that encompasses, i.e., corresponds to, the $1,750.00 Monthly Mortgage Payment input into input section and having a credit score range that encompasses, i.e. corresponds to, the 700 Credit Score previously input into input section 120. In this example, loan stores 34C and 34G each include a Good Credit Score range of 690-719 under the “UPPER HOME MORTGAGE MONTHLY PAYMENT RANGE” that encompasses the input 700 Credit Score and an Upper Home Mortgage Monthly Payment Range that encompasses the input $1,750.00 Monthly Mortgage Payment. Since by default processor 31 initially posted the “Good” loan products 37 under the “LOWER HOME MORTGAGE MONTHLY PAYMENT RANGE” of the retrieved loan stores, loan stores 34C and 34G in this example, processor 31 in communication with computer warehouse 32 and posting section 121 is dynamically responsive on-the-go and in real-time to entry into input section 120 of the $1,750.00 Monthly Mortgage Payment and overwrites the posts in posting section 121 of webpage 66A in FIG. 12 with, as shown in FIG. 16, the “Good” loan products 37 under the “UPPER HOME MORTGAGE MONTHLY PAYMENT RANGE” of the retrieved loan stores, loan stores 34C and 34G in this example. The user using user computer 23A then, as discussed in connection with FIG. 14, completes the form in FIG. 17 and selects the loan select control 140 next to the borrower's elected loan product, loan select control 140′ next to the “Term 48-months: Rate 5%: monthly Payment $806.00” ABC Bank loan product in this example. Again, processor 31 is programmed via instructions 51 to automatically receive from the web browser of the computer user using user computer 23A a signal indicating activation of the selected loan select control 140 of webpage 66A in FIG. 17 and associated with selected loan terms posted to website 66A, loan select control 140′ next to the “Term 48-months: Rate 5%: monthly Payment $806.00” ABC Bank loan product in this example, automatically link the selected loan terms to external link 150 of posting section 121 of webpage 66A, and receive from the web browser of the computer user a signal indicating activation of external link 150 constituting an acceptance by the borrower of the selected loan terms posted to posting section 121 of website 66A. In response to processor 31 receiving the signal indicating activation of external posting link 150, processor 31 automatically overwrites all loan products from posting section 121 with the selected loan product 37, and posts an acceptance message in posting section 121, “ACCEPTED!!” in this example, constituting an acceptance by the borrower and the lender of the selected loan product 37 posted to webpage 66A of website 25, shown in FIG. 18. The consumer loan is then finalized by loan document execution in the normal manner from the information in loan application webpage 65A and the product is delivered to the borrower, typically at the seller's retail location.

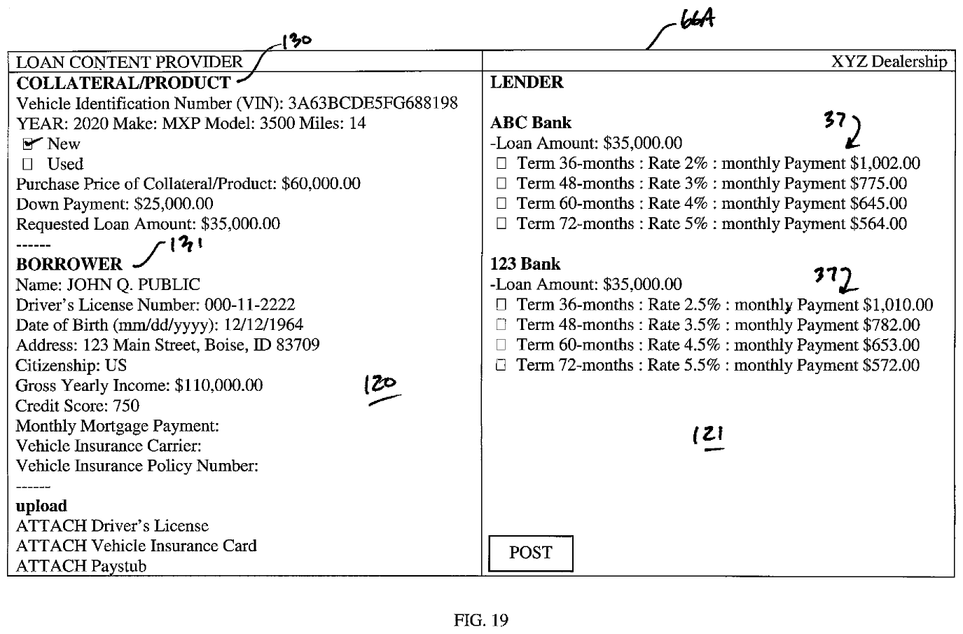

In another embodiment during the loan application entry process from webpage 66A in FIG. 11, the user using user computer 23A fills in the Credit Score, previously determined/known, of the borrower in FIG. 19, which is 750 in this example. Upon entry into input section 120 of the borrower's 750 Credit Score, information that corresponds the credit score factors of the lending criteria 36 of the retrieved loan stores 34C and 34G, processor 31 in communication with input section 120 is responsive and automatically receives it, automatically compares it to the credit score ranges of the retrieved loan stores 34C and 34G, and automatically retrieves loan products 37 under the “LOWER HOME MORTGAGE MONTHLY PAYMENT RANGE” from any of the retrieved loan stores 34C and 34G having a credit score range that encompasses, i.e. corresponds to, the 750 Credit Score input into input section 120. In this example, loan stores 34C and 34G each include an Excellent Credit Score range of 720-850 under the “LOWER HOME MORTGAGE MONTHLY PAYMENT RANGE” that encompasses the input 750 input Credit Score. Since by default processor 31 initially posted the “Good” loan products 37 under the “LOWER HOME MORTGAGE MONTHLY PAYMENT RANGE” of the retrieved loan stores, loan stores 34C and 34G in this example, processor 31 in communication with computer warehouse 32 and posting section 121 is responsive on-the-go and in real-time to entry into input section 120 of the 705 credit score and overwrites the posts in posting section 121 of webpage 66A in FIG. 11 with, as shown in FIG. 19, the “Excellent” loan products 37 under the “LOWER HOME MORTGAGE MONTHLY PAYMENT RANGE” of the retrieved loan stores, loan stores 34C and 34G in this example.

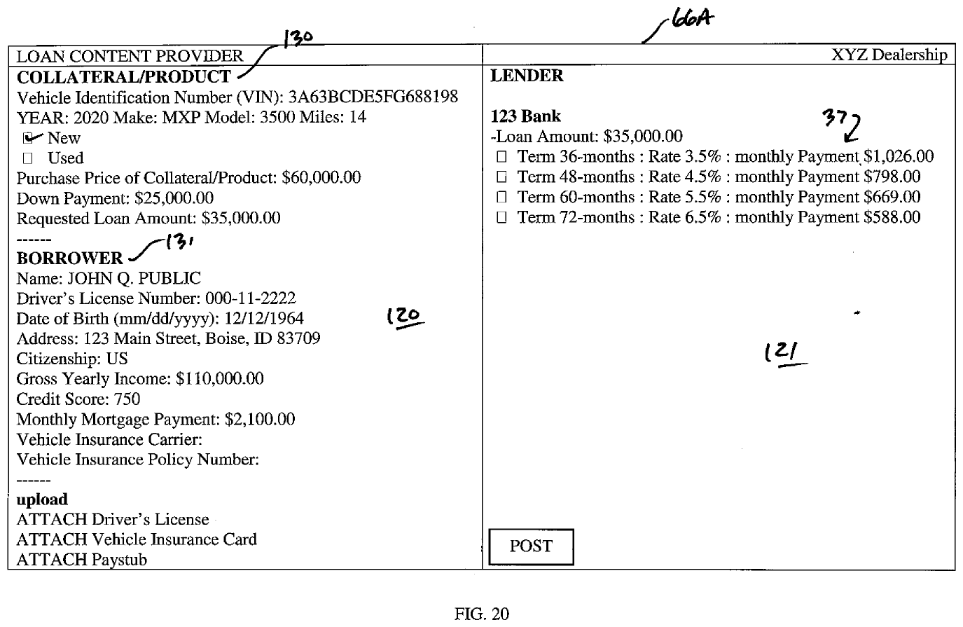

The user using user computer 23A then fills in the Monthly Mortgage Payment of the borrower in FIG. 20, which is $2,100.00 in this example. Upon entry into input section 120 of the borrower's $2,100.00 Monthly Mortgage Payment, information that corresponds the monthly mortgage payment ranges of the lending criteria 36 of the retrieved loan stores 34C and 34G, processor 31 in communication with input section 120 is responsive and automatically receives it, automatically compares it to the monthly mortgage payment ranges of the retrieved loan stores 34C and 34G, and, automatically retrieves loan products 37 the from the retrieved loan stores 34C and 34G having a monthly mortgage payment range that encompasses, i.e., corresponds to, the $2,100.00 Monthly Mortgage Payment input into input section and having a credit score range that encompasses, i.e. corresponds to, the 750 Credit Score previously input into input section 120. In this example, only loan store 34G has an Excellent Credit Score range of 720-850 under the “UPPER HOME MORTGAGE MONTHLY PAYMENT RANGE” that encompasses the input 750 Credit Score and an Upper Home Mortgage Monthly Payment Range that encompasses the input $2,100.00 Monthly Mortgage Payment. From the previously-posted “Excellent” loan products 37 under the “LOWER HOME MORTGAGE MONTHLY PAYMENT RANGE” of the retrieved loan stores 34C and 34G in FIG. 19, processor 31 in communication with computer warehouse 32 and posting section 121 is responsive on-the-go and in real-time to entry into input section 120 of the $2,100.00 Monthly Mortgage Payment and overwrites the posts in posting section 121 of webpage 66A in FIG. 19 with, as shown in FIG. 20, the “Excellent” loan products 37 under the “UPPER HOME MORTGAGE MONTHLY PAYMENT RANGE” of only retrieved loan store 34G in this example.

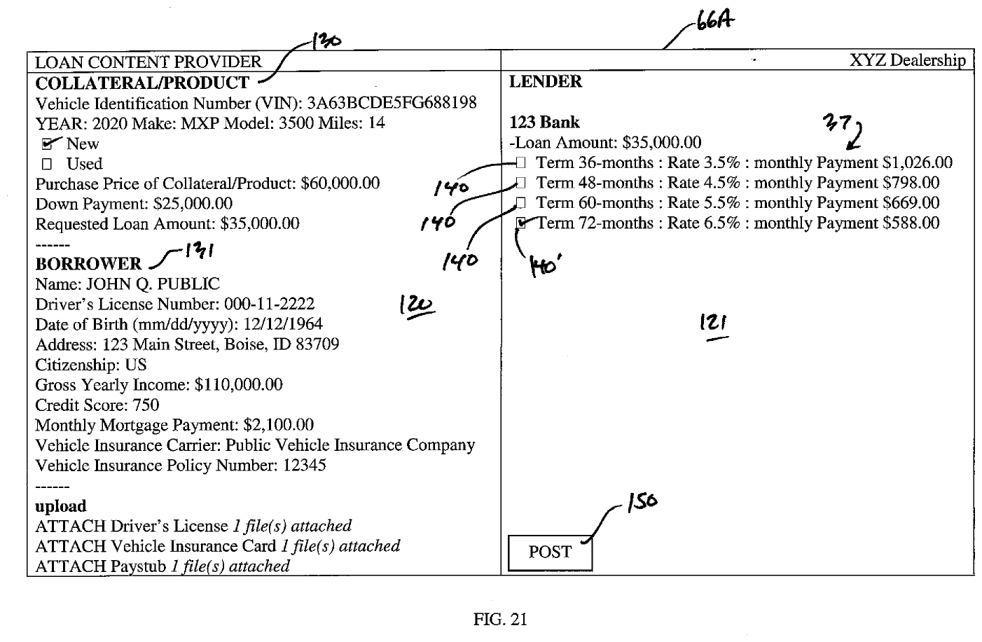

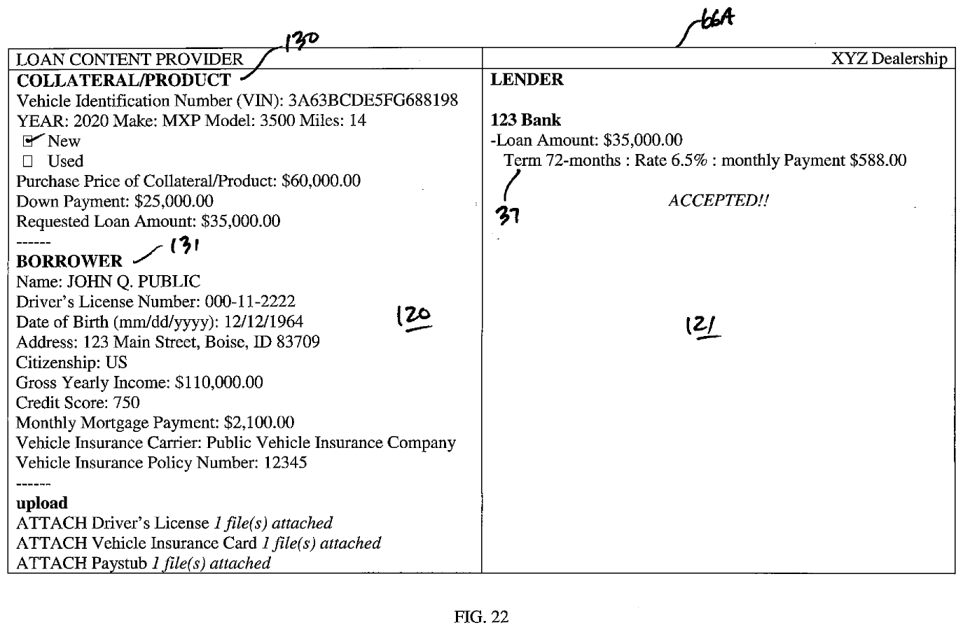

The seller using user computer 23A then, as discussed before, completes the form in FIG. 21 and selects the loan select control 140 next to the borrower's elected loan product, loan select control 140′ next to the “Term 72-months: Rate 6.5%: monthly Payment $588.00” 123 ABC Bank loan product in this example. Again, processor 31 is programmed via instructions 51 to automatically receive from the web browser of the computer user using user computer 23A a signal indicating activation of the selected loan select control 140 of webpage 66A in FIG. 21 and associated with selected loan terms posted to website 66A, loan select control 140′ next to the “Term 72-months: Rate 6.5%: monthly Payment $588.00” 123 Bank loan product in this example, automatically link the selected loan terms to external link 150 of posting section 121 of webpage 66A, and receive from the web browser of the computer user a signal indicating activation of external link 150 constituting an acceptance by the borrower of the selected loan terms posted to posting section 121 of website 66A. In response to processor 31 receiving the signal indicating activation of external posting link 150, processor 31 automatically overwrites all loan products from posting section 121 except for the selected loan product 37, and posts an acceptance message in posting section 121, “ACCEPTED!!” in this example, constituting an acceptance by the borrower and the associated lender of the selected loan product 37 posted to webpage 66A of website 25, shown in FIG. 22. As in the previous embodiments, the consumer loan is then finalized by loan document execution in the normal manner from the information in loan application webpage 65A and the product is delivered to the borrower, typically at the seller's retail location.

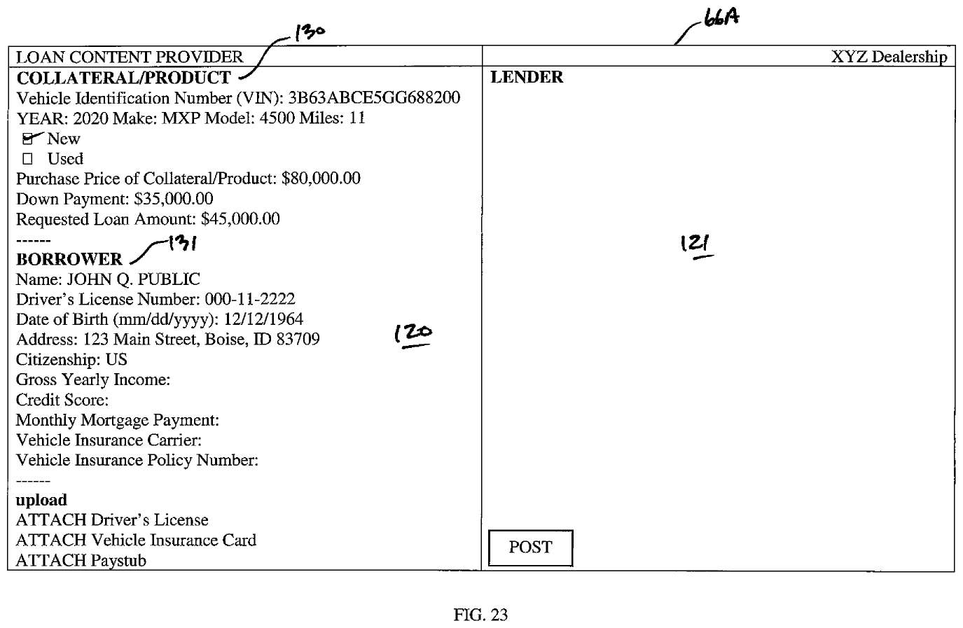

Another automatic loan underwriting process will now be discussed from the beginning in conjunction with FIGS. 23-29. It is again assumed in this additional example that the borrower is ready to purchase a vehicle from XYZ Dealership, that the borrower and XYZ Dealership have agreed to the vehicle the borrower intends to purchase and its purchase price. To initiate the underwriting/financing process, from webpage 66A in FIG. 23 the user using user computer 23A initially fills in webpage 66A in FIG. 23 and inputs collateral and borrower information in the respective collateral and borrower categories 130 and 131 of input section 120. The vehicle designated in FIG. 23 is fictitious, is presented by way of example, and does not represent any actual vehicle or vehicle brand. The designated borrower in FIG. 23 likewise is fictitious, is presented by way of example, and does not represent any actual person.

Upon entry into input section 120 of the requested loan amount of $45,000.00, information that corresponds the loan amount range of the lending criteria 36 of the loan stores 34, processor 31 in communication with input section 120 is responsive and automatically receives it, automatically compares it to the loan amount ranges of the loan stores 34 of computer warehouse 32, and automatically retrieves any loan store 34 having a loan amount range that encompasses, i.e. corresponds to, the requested loan amount of $45,000.00, on-the-go and in real-time. In this example, loan stores 34D and 34H each include a loan amount range that encompasses the requested loan amount of $45,000.00. As a result, processor 31 automatically retrieves loan stores 34D and 34H in response to entry of the $45,000.00 requested loan amount in input section 120 of webpage 66A in FIG. 23.

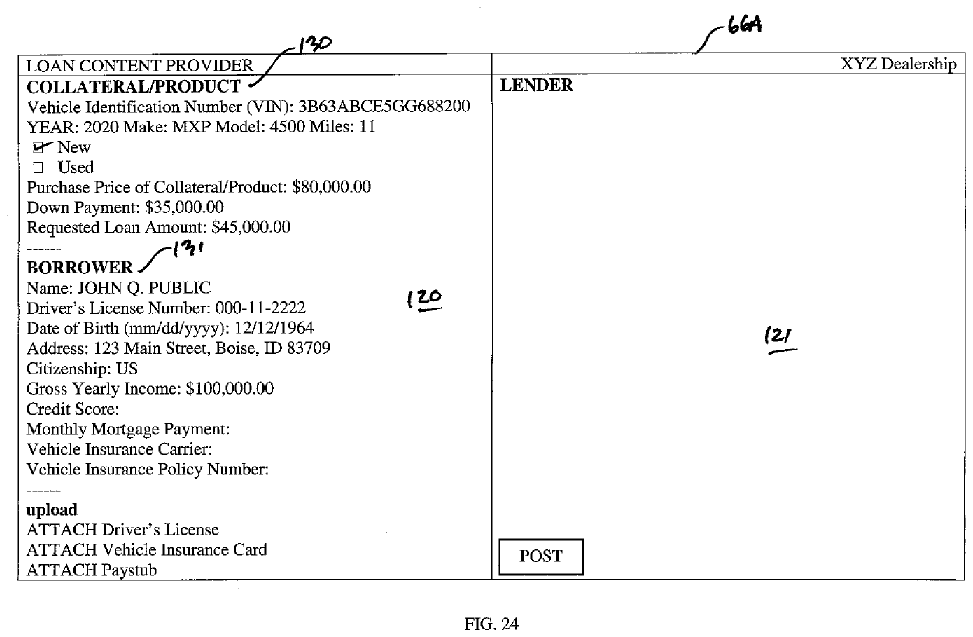

The user using user computer 23A then fills in the Gross Yearly Income of the borrower in FIG. 24, which is $100,000.00 in this example. Upon entry into input section 120 of the borrower's gross Yearly income of $100,000.00, information that corresponds the income range of the lending criteria 36 of the retrieved loan stores 34D and 34H, processor 31 in communication with input section 120 is responsive and automatically receives it, automatically compares it to the income ranges of the retrieved loan stores 34D and 34H, and automatically retrieves loan products 37 from any of the retrieved loan stores 34D and 34H having an income range that encompasses, i.e. corresponds to, the $100,000.00 Gross Annual Income input into input section 120. In this example, loan stores 34D and 34H each include an income range of $125,000.00-$150,000.00 that does not encompass the input $100,000.00 Gross Annual Income. As a result, processor 31 is automatically unresponsive and does not retrieve any loan products 37 from loan stores 34D and 34H and posts no loan products 37 to posting section 121 in FIG. 24 on-the-go and in real-time, according to the invention, which effectively ends the process, there being no available options for the borrower having a gross annual income that is too low to in relation to the corresponding $45,000.00 loan amount.

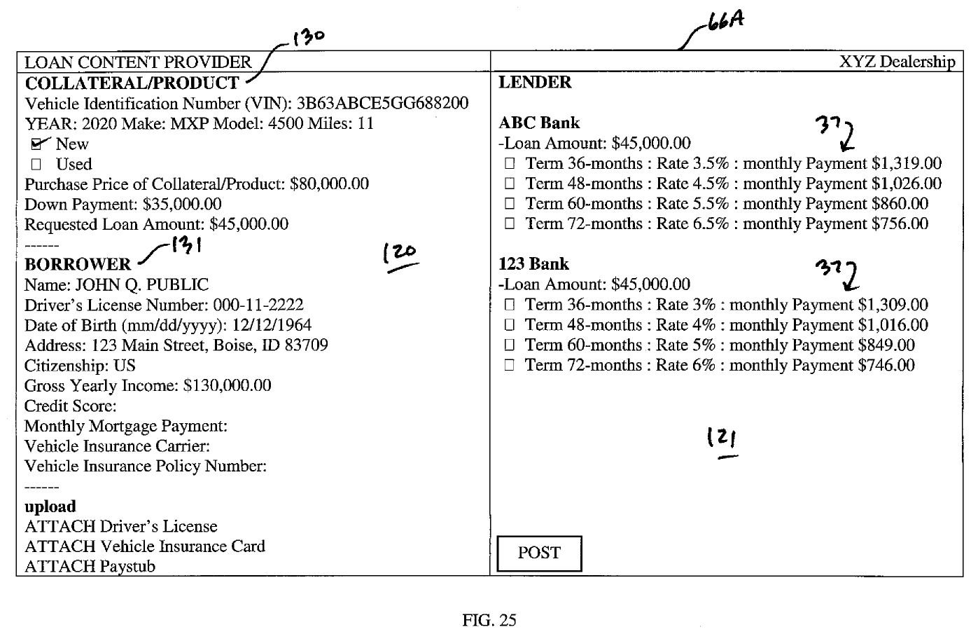

In an alternate embodiment, in FIG. 25, the user using user computer 23A then fills in the Gross Yearly Income of the borrower, which is $130,000.00 in this example. Upon entry into input section 120 of the borrower's gross Yearly income of $130,000.00, information that corresponds the income range of the lending criteria 36 of the retrieved loan stores 34D and 34H, processor 31 in communication with input section 120 is responsive and automatically receives it, automatically compares it to the income ranges of the retrieved loan stores 34D and 34H, and automatically retrieves loan products 37 from any of the retrieved loan stores 34D and 34H having an income range that encompasses, i.e. corresponds to, the $130,000.00 Gross Annual Income input into input section 120. In this example, loan stores 34D and 34H each include an income range of $125,000.00-$150,000.00 that encompasses the input $130,000.00 Gross Annual Income. As a result, processor 31 in communication with computer warehouse 32 and posting section 121 automatically retrieves loan products 37 from loan stores 34D and 34H and posts them to posting section 121 in FIG. 25 in response all on-the-go and in real-time, according to the invention.

Posted to posting section 121 in FIG. 25 are loan store 34D loan products 37 for ABC Bank, and loan store 34H loan products for 123 Bank. By default, as a matter of example, processor 31 is programmed to initially retrieve the “Good” loan products 37 under the “LOWER HOME MORTGAGE MONTHLY PAYMENT RANGE” of the retrieved loan stores, loan stores 34D and 34H in this example, and post them to posting section 121 as shown in FIG. 25. This is a chosen starting point in an illustrative embodiment. At the same time, loan calculator 44 automatically calculates the monthly payment for each of loan products 37, which processor includes in each posted product 37 as shown in FIG. 25. This way, as previously explained, the monthly payment for each loan product 37 is available for immediate reference. There are four loan products 37 under each of ABC Bank and 123 Bank corresponding to the 36-, 48-, 60-, and 72-month “Good” loan products 37 under the “LOWER HOME MORTGAGE MONTHLY PAYMENT RANGE” of the respective loan stores 34D and 34H. These ABC Bank and 123 Bank loan product postings presented to the user using user computer 23A are inherently competitive postings between the inherently diverse banks, and provide the borrower with immediate feedback in the nature of potential loan products of diverse lenders, ABC Bank and 123 Bank in this example, as previously explained.

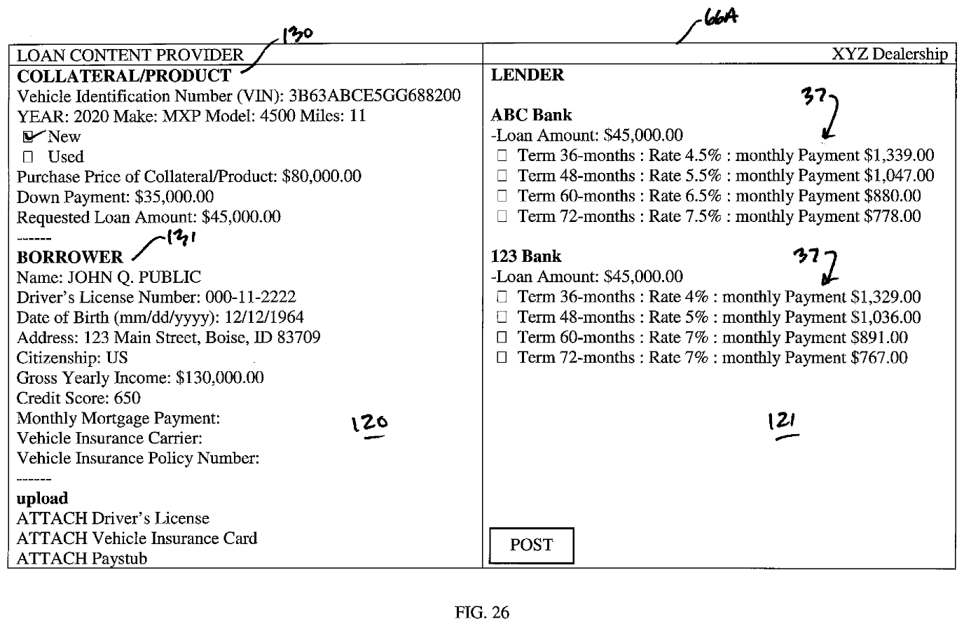

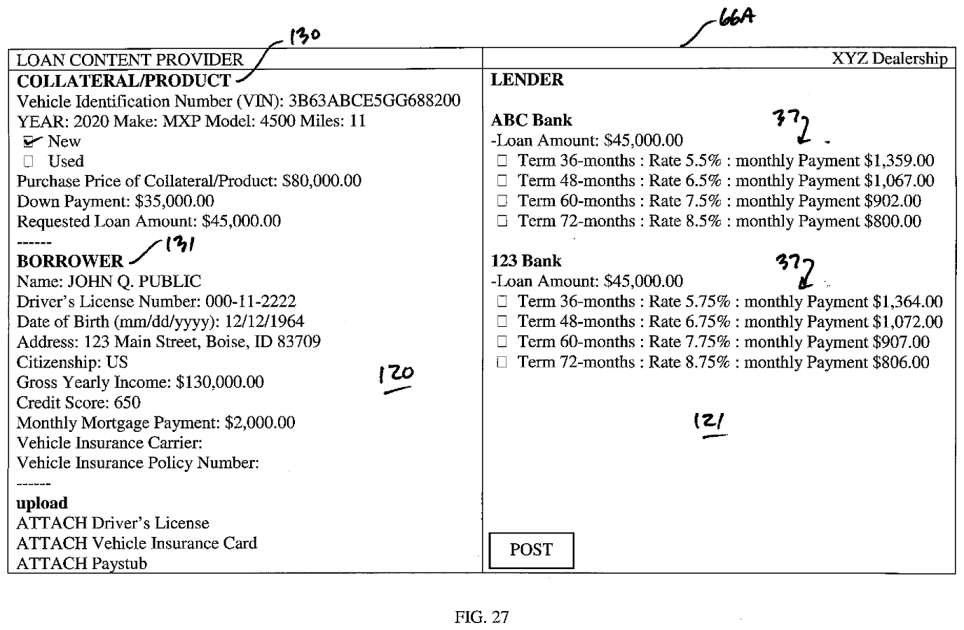

The user using user computer 23A then fills in the Credit Score, previously determined/known, of the borrower in FIG. 26, which is 650 in this example. Upon entry into input section 120 of the borrower's 650 Credit Score, information that corresponds the credit score factors of the lending criteria 36 of the retrieved loan stores 34D and 34H, processor 31 in communication with input section 120 is responsive and automatically receives it, automatically compares it to the credit score ranges of the retrieved loan stores 34D and 34H, and automatically retrieves loan products 37 under the “LOWER HOME MORTGAGE MONTHLY PAYMENT RANGE” from any of the retrieved loan stores 34D and 34H having a credit score range that encompasses, i.e. corresponds to, the 650 Credit Score input into input section 120. In this example, loan stores 34D and 34H each include a Fair Credit Score range of 630-689 under the “LOWER HOME MORTGAGE MONTHLY PAYMENT RANGE” that encompasses the input 650 input Credit Score. Since by default processor 31 initially posted the “Good” loan products 37 under the “LOWER HOME MORTGAGE MONTHLY PAYMENT RANGE” of the retrieved loan stores, loan stores 34D and 34H in this example, processor 31 in communication with input section 120 is responsive on-the-go and in real-time to entry into input section 120 of the 700 credit score and overwrites the posts in posting section 121 of webpage 66A in FIG. 25 with, as shown in FIG. 26, the “Fair” loan products 37 under the “LOWER HOME MORTGAGE MONTHLY PAYMENT RANGE” of the retrieved loan stores, loan stores 34D and 34G in this example.

The user using user computer 23A then fills in the Monthly Mortgage Payment of the borrower in FIG. 27, which is $2,000.00 in this example. Upon entry into input section 120 of the borrower's $2,00.00 Monthly Mortgage Payment, information that corresponds the monthly mortgage payment ranges of the lending criteria 36 of the retrieved loan stores 34D and 34G, processor 31 in communication with input section 120 is responsive and automatically receives it, automatically compares it to the monthly mortgage payment ranges of the retrieved loan stores 34D and 34G, and, automatically retrieves loan products 37 the from the retrieved loan stores 34D and 34G having a monthly mortgage payment range that encompasses, i.e., corresponds to, the $2,00.00 Monthly Mortgage Payment input into input section and having a credit score range that encompasses, i.e. corresponds to, the 650 Credit Score previously input into input section 120. In this example, loan stores 34D and 34G each include a Fair Credit Score range of 630-689 under the “UPPER HOME MORTGAGE MONTHLY PAYMENT RANGE” that encompasses the input 650 Credit Score and an Upper Home Mortgage Monthly Payment Range that encompasses the input $2,000.00 Monthly Mortgage Payment. Since processor 31 previously posted the “Fair” loan products 37 under the “LOWER HOME MORTGAGE MONTHLY PAYMENT RANGE” of the retrieved loan stores, loan stores 34D and 34G in this example, processor 31 in communication with computer warehouse 32 and posting section 121 is responsive on-the-go and in real-time to entry into input section 120 of the $2,000.00 Monthly Mortgage Payment and overwrites the posts in posting section 121 of webpage 66A in FIG. 26 with, as shown in FIG. 27, the “Fair” loan products 37 under the “UPPER HOME MORTGAGE MONTHLY PAYMENT RANGE” of the retrieved loan stores, loan stores 34D and 34G in this example.

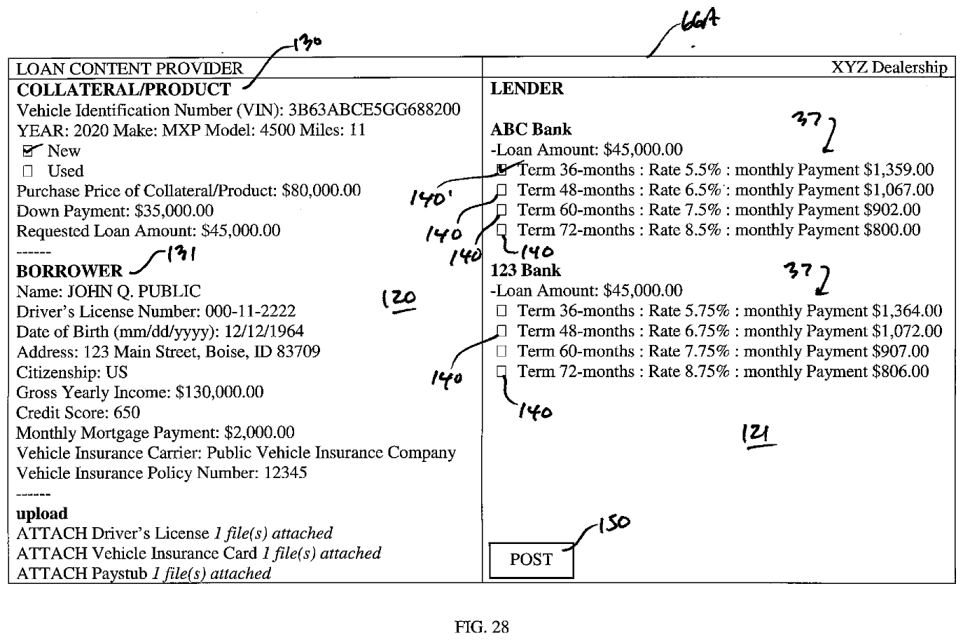

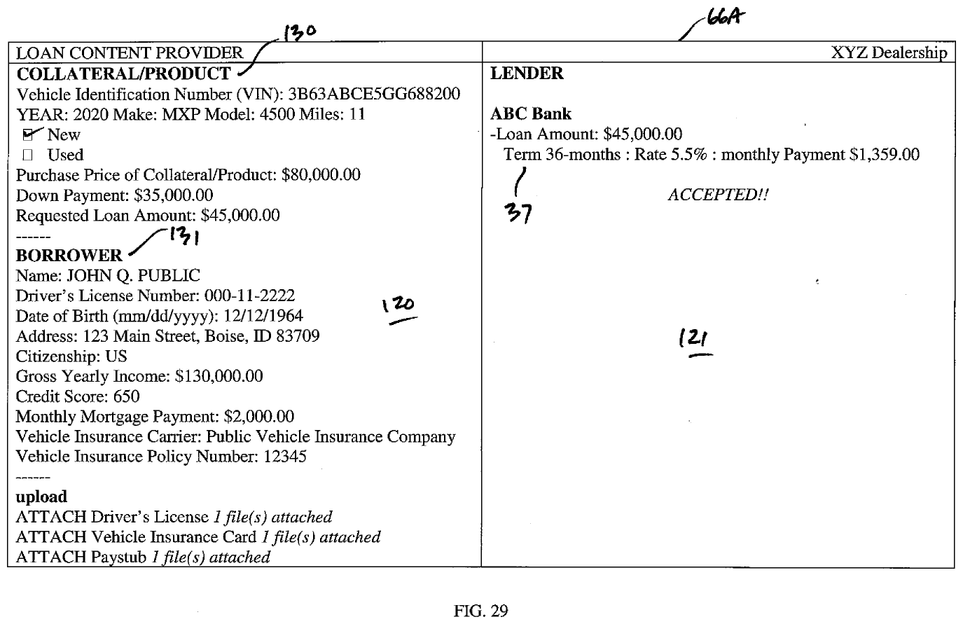

The user using user computer 23A then, as discussed in connection with FIG. 14, completes the form in FIG. 28 and selects the loan select control 140 next to the borrower's elected loan product, loan select control 140′ next to the “Term 36-months: Rate 5.5%: monthly Payment $1,359.00” ABC Bank loan product in this example. Again, processor 31 is programmed via instructions 51 to automatically receive from the web browser of the computer user using user computer 23A a signal indicating activation of the selected loan select control 140 of webpage 66A in FIG. 29 and associated with the selected loan product 37 posted to website 66A, loan select control 140′ next to the “Term 36-months: Rate 5.5%: monthly Payment $1,359.00” ABC Bank loan product in this example, automatically link the selected loan product 37 to external link 150 of posting section 121 of webpage 66A, and receive from the web browser of the computer user a signal indicating activation of external link 150 constituting an acceptance by the borrower of the selected loan product 37 posted to posting section 121 of website 66A. In response to processor 31 receiving the signal indicating activation of external posting link 150, processor 31 automatically overwrites all loan products from posting section 121 except for the selected loan product 37, and posts an acceptance message in posting section 121, “ACCEPTED!!” in this example, constituting an acceptance by the borrower and the lender of the loan product 37 posted to webpage 66A of website 25, shown in FIG. 29. As before, the consumer loan is then finalized by loan document execution in the normal manner from the information in loan application webpage 65A and the product is delivered to the borrower, typically at the seller's retail location.

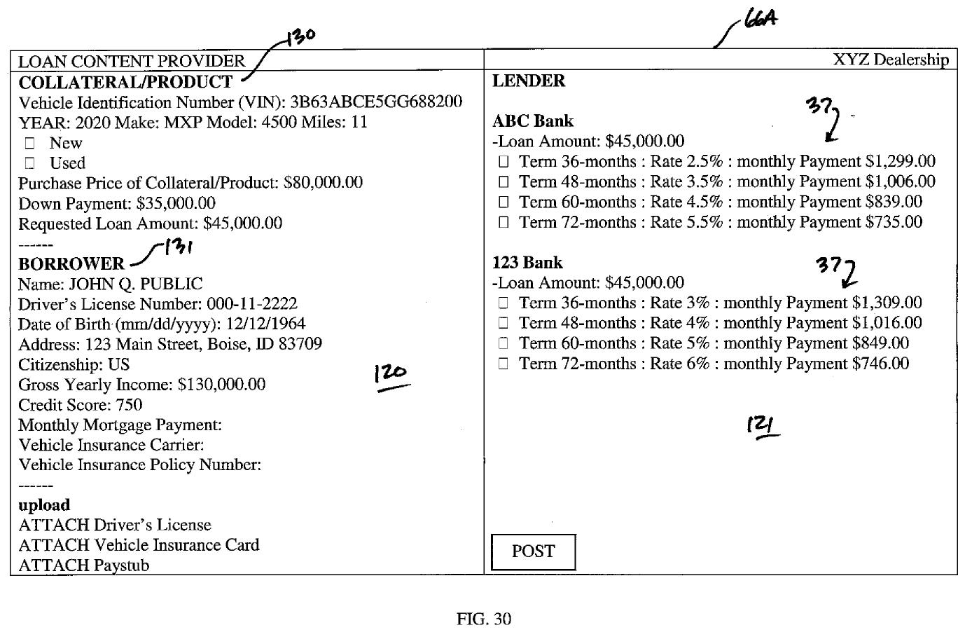

In still another embodiment during the loan application entry process from webpage 66A in FIG. 25, the user using user computer 23A fills in the Credit Score, previously determined/known, of the borrower in FIG. 30, which is 750 in this example. Upon entry into input section 120 of the borrower's 750 Credit Score, information that corresponds the credit score factors of the lending criteria 36 of the retrieved loan stores 34D and 34H, processor 31 in communication with input section 120 is responsive and automatically receives it, automatically compares it to the credit score ranges of the retrieved loan stores 34D and 34H, and automatically retrieves loan products 37 under the “LOWER HOME MORTGAGE MONTHLY PAYMENT RANGE” from any of the retrieved loan stores 34D and 34H having a credit score range that encompasses, i.e. corresponds to, the 750 Credit Score input into input section 120. In this example, loan stores 34D and 34H each include an Excellent Credit Score range of 720-850 under the “LOWER HOME MORTGAGE MONTHLY PAYMENT RANGE” that encompasses the input 750 input Credit Score. Since by default processor 31 initially posted the “Good” loan products 37 under the “LOWER HOME MORTGAGE MONTHLY PAYMENT RANGE” of the retrieved loan stores, loan stores 34D and 34H in this example, processor 31 in communication with computer warehouse 32 and posting section 121 is responsive on-the-go and in real-time to entry into input section 120 of the 705 credit score and overwrites the posts in posting section 121 of webpage 66A in FIG. 25 with, as shown in FIG. 30, the “Excellent” loan products 37 under the “LOWER HOME MORTGAGE MONTHLY PAYMENT RANGE” of the retrieved loan stores, loan stores 34D and 34H in this example.

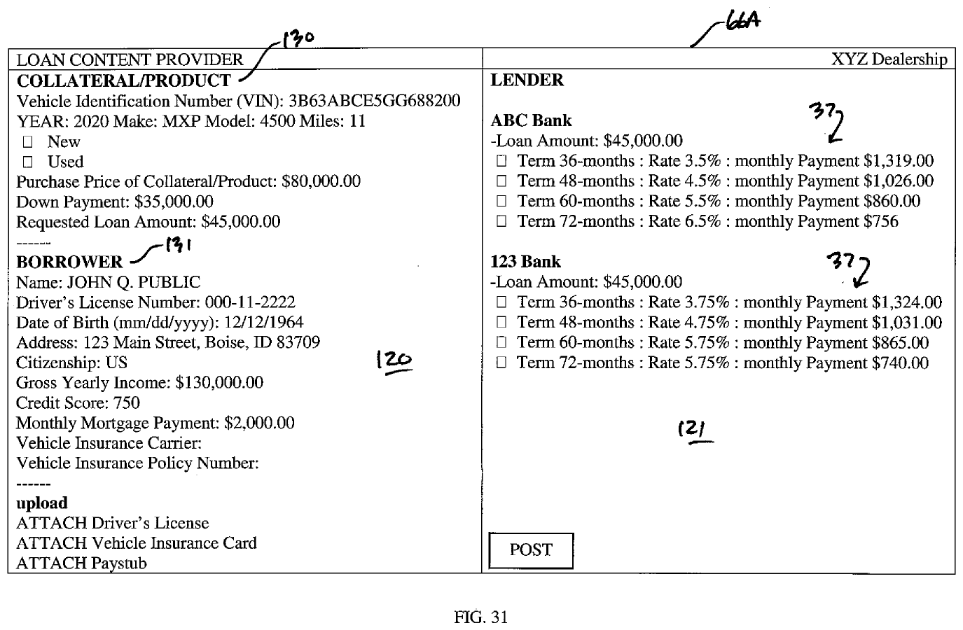

The user using user computer 23A then fills in the Monthly Mortgage Payment of the borrower in FIG. 31, which is $2,000.00 in this example. Upon entry into input section 120 of the borrower's $2,000.00 Monthly Mortgage Payment, information that corresponds the monthly mortgage payment ranges of the lending criteria 36 of the retrieved loan stores 34D and 34H, processor 31 in communication with input section 120 is responsive and automatically receives it, automatically compares it to the monthly mortgage payment ranges of the retrieved loan stores 34D and 34H, and, automatically retrieves loan products 37 the from the retrieved loan stores 34D and 34H having a monthly mortgage payment range that encompasses, i.e., corresponds to, the $2,000.00 Monthly Mortgage Payment input into input section and having a credit score range that encompasses, i.e. corresponds to, the 750 Credit Score previously input into input section 120. In this example, loan stores 34D and 34H each have an Excellent Credit Score range of 720-850 under the “UPPER HOME MORTGAGE MONTHLY PAYMENT RANGE” that encompasses the input 750 Credit Score and an Upper Home Mortgage Monthly Payment Range that encompasses the input $2,000.00 Monthly Mortgage Payment. From the previously-posted “Excellent” loan products 37 under the “LOWER HOME MORTGAGE MONTHLY PAYMENT RANGE” of the retrieved loan stores 34D and 34H in FIG. 30, processor 31 in communication with computer warehouse 32 and posting section 121 is responsive on-the-go and in real-time to entry into input section 120 of the $2,000.00 Monthly Mortgage Payment and overwrites the posts in posting section 121 of webpage 66A in FIG. 30 with, as shown in FIG. 31, the “Excellent” loan products 37 under the “UPPER HOME MORTGAGE MONTHLY PAYMENT RANGE” of retrieved loan stores 34D and 34H in this example.

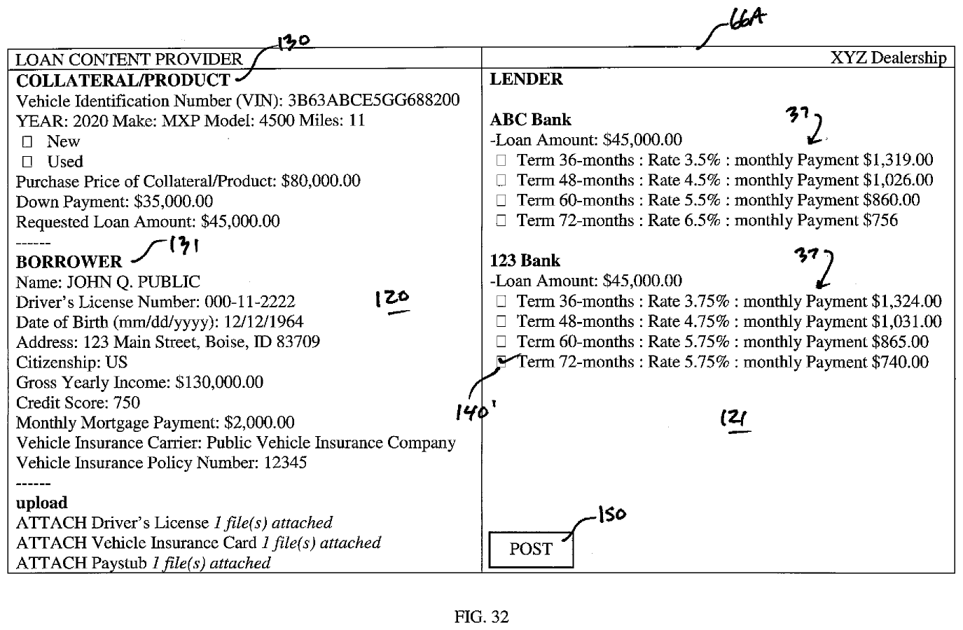

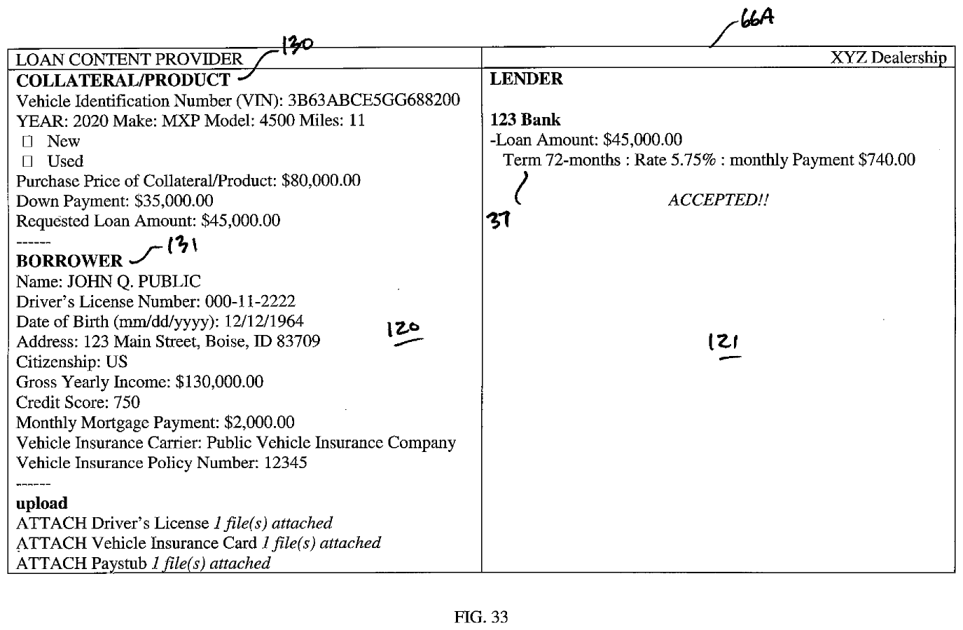

The user using user computer 23A then, as discussed before, completes the form in FIG. 32 and selects the loan select control 140 next to the borrower's elected loan product, loan select control 140′ next to the “Term 72-months: Rate 5.75%: monthly Payment $740.00” 123 ABC Bank loan product in this example. Again, processor 31 is programmed via instructions 51 to automatically receive from the web browser of the computer user using user computer 23A a signal indicating activation of the selected loan select control 140 of webpage 66A in FIG. 32 and associated with the selected loan product 37 posted to website 66A, loan select control 140′ next to the “Term 72-months: Rate 5.75%: monthly Payment $740.00” 123 Bank loan product in this example, automatically link the selected loan product 37 to external link 150 of posting section 121 of webpage 66A, and receive from the web browser of the computer user a signal indicating activation of external link 150 constituting an acceptance by the borrower of the selected loan product 37 posted to posting section 121 of website 66A. In response to processor 31 receiving the signal indicating activation of external posting link 150, processor 31 automatically overwrites all loan products from posting section 121 except for the selected loan product 37, and posts an acceptance message in posting section 121, “ACCEPTED!!” in this example, constituting an acceptance by the borrower and the lender of the selected loan product 37 posted to webpage 66A of website 25, shown in FIG. 33. Again, the consumer loan is then finalized by loan document execution in the normal manner from the information in loan application webpage 65A and the product is delivered to the borrower, typically at the seller's retail location.

The various embodiments of the invention disclosed throughout this specification demonstrate that processor 31 of provider 26 in communication with computer warehouse 32 of loan stores 34 and loan application webpages 66 is configured to enable borrowers to become qualified for loans and offered qualifying loan products at loan application webpages 66 on-the-go and in real time in only the time used to enter loan application to processor 31 via the loan application webpages 66 by computer users using user computers 23 in communication with the loan application webpages 66 via Internet 21, according to the invention. Accordingly, those having regard for the art will readily appreciate that exemplary automatic, electronic, and dynamic systems and methods for electronically underwriting loan application information and posting loan products of diverse lenders to webpages 66 from loan content provider 26 on-the-go and in real-time upon entry of loan application information to loan content provider 26 via webpages 66 for expanding lending opportunities for lenders and borrowing opportunities for borrowers at the webpages 66 are disclosed. It is again emphasized that the loan products 37 posted to the webpages 66 of provider 26 serve the commercial purposes of improving the speed and efficiency of the loan application process for the sellers and borrowers, creating a competitive online environment for lenders to directly compete for customer loan business during loan application processes and creating interest by the prospective borrowers visiting the webpages with loan products of the various lenders, for providing the lenders with the commercial opportunity to service consumer loans and for providing the borrowers visiting the webpages with the commercial opportunity of securing loan products having favorable terms. The unique installation of loan stores 34 of loan underwriting webpages 65 at computer warehouse 32 represents a competitive on-line environment where the loan stores 34 compete for loan business at loan application webpages 66 based on loan application information entered into provider 26 from the loan application webpages 66. The loan application information can vary and can be entered in any order consistent with the teachings presented herein, and processor 31 is programmed automatically effectuate its operations in response. The loan products 37 of the loan stores 34 posted to the loan application websites 66 on-the-go and in real-time during entry of loan application information at the loan application websites 66 promote competition amongst diverse participating lenders, provide the lenders with commercial opportunities at the loan application websites 66 to service consumer loans, and to provide borrowers visiting the loan application websites 66 with competitive loan products from diverse lenders and opportunities to secure favorable loans.

The various embodiments of the invention are discussed above with a borrower applying for a secured loan to purchase a vehicle from a vehicle dealership. The various embodiments of the invention are equally useful in the fields of boats, recreational vehicles, motor homes, and other like or similarly expensive durable goods and other products, including real estate, sold by dealerships, sellers, agents for the seller and the like, products that most consumers customarily purchase in the same way as vehicles, by collateralized or secured financing, namely, by borrowing the money from a lender to pay for the product pledged as collateral and then paying off the lender in installments. While the various embodiments of the invention are discussed above with a borrower applying for a secured loan to purchase a product, the various embodiments of the invention are equally useful in the application/financing process in the fields of student loans, personal loans, and credit cards, forms of unsecured loans in which money is borrowed from a lender without being secured by an asset. It is to be understood that the lending criteria and the loan application information can vary and are chosen to correspond to the loan type.

The present invention is described above with reference to illustrative embodiments. However, those skilled in the art will recognize that changes and modifications may be made in the described embodiments without departing from the nature and scope of the present invention. Various further changes and modifications to the embodiments herein chosen for purposes of illustration will readily occur to those skilled in the art. To the extent that such modifications and variations do not depart from the spirit of the invention, they are intended to be included within the scope thereof. Having fully described the invention in such clear and concise terms as to enable those skilled in the art to understand and practice the same, the invention claimed is:

1. An electronic loan underwriting system, comprising:
a computer warehouse serving a webpage and containing loan stores each including lending criteria and loan products of a lender; and
a processor coupled to the computer warehouse and the webpage and programmed to receive from a web browser of a computer user loan application information about a borrower applying for a loan and for each said loan store as the loan application information is being received by the processor both automatically a) compare the loan application information to the lending criteria and b) selectively post the loan products to the webpage on-the-go in real-time upon the loan application information corresponding to the lending criteria.

2. The system according to claim 1, wherein the processor is additionally programmed to receive from the web browser of the computer user a signal indicating activation of a loan select control of the webpage and associated with a selected loan product posted to the website, automatically link the selected loan product to an external link of the webpage, and receive from the web browser of the computer user a signal indicating activation of the external link constituting an acceptance by the borrower of the selected loan product.

3. The system according to claim 1, wherein the loan stores are different from one another.

4. The system according to claim 1, wherein the lending criteria comprise creditworthiness factors that bear on an extent to which the borrower is considered suitable to receive credit.

5. The system according to claim 1, wherein the loan products each comprise a loan amount, a term, and an interest rate.

6. The system according to claim 1, wherein the loan application information comprises an identification of the borrower, and creditworthiness data about the borrower.

7. The system according to claim 1, wherein the loan is to purchase a product for sale by a seller and pledged by the borrower as collateral for the loan via the webpage.

8. An electronic loan underwriting system, comprising:
a computer warehouse serving a webpage and containing loan stores each including lending criteria and loan products of a lender;
a processor coupled to the computer warehouse and the webpage; and
a computer readable storage medium that is not a signal storing computer executable instructions that when executed by the processor cause the processor to effectuate operations comprising receiving from a web browser of a computer user loan application information about a borrower applying for a loan and for each said loan store as the loan application information is being received by the processor both automatically a) comparing the loan application information to the lending criteria and b) selectively posting the loan products to the webpage on-the-go in real-time upon the loan application information corresponding to the lending criteria.

9. The system according to claim 8, the operations additionally comprising receiving from the web browser of the computer user a signal indicating activation of a loan select control of the webpage and associated with a selected loan product posted to the website, automatically linking the selected loan product to an external link of the webpage, and receiving from the web browser of the computer user a signal indicating activation of the external link constituting an acceptance by the borrower of the selected loan product.

10. The system according to claim 8, wherein the loan stores are different from one another.

11. The system according to claim 8, wherein the lending criteria comprise creditworthiness factors that bear on an extent to which the borrower is considered suitable to receive credit.

12. The system according to claim 8, wherein the loan products each comprise a loan amount, a term, and an interest rate.

13. The system according to claim 8, wherein the loan application information comprises an identification of the borrower, and creditworthiness data about the borrower.

14. The system according to claim 8, wherein the loan is to purchase a product for sale by a seller and pledged by the borrower as collateral for the loan via the webpage.

15. An electronic loan underwriting method, comprising:
establishing a computer warehouse serving a webpage and containing loan stores each including products and lending criteria of a lender, and a processor coupled to the computer warehouse and the webpage; and
the processor receiving from a web browser of a computer user loan application information about a borrower applying for a loan and for each said loan store as the loan application information is being received by the processor both automatically a) comparing the loan application information to the lending criteria and b) selectively posting the loan products to the webpage on-the-go in real-time upon the loan application information corresponding to the lending criteria.

16. The method according to claim 15, the operations additionally comprising receiving from the web browser of the computer user a signal indicating activation of a loan select control of the webpage and associated with a selected loan product posted to the posting section, automatically linking the selected loan product to an external link of the webpage, and receiving from the web browser of the computer user a signal indicating activation of the external link constituting an acceptance by the borrower of the selected loan product.

17. The method according to claim 15, wherein the loan stores are different from one another.

18. The method according to claim 15, wherein the lending criteria comprise creditworthiness factors that bear on an extent to which the borrower is considered suitable to receive credit.

19. The method according to claim 15, wherein the loan products each comprise a loan amount, a term, and an interest rate.

20. The method according to claim 15, wherein the loan application information comprises an identification of the borrower, and creditworthiness data about the borrower.

21. The method according to claim 15, wherein the loan is to purchase a product for sale by a seller and pledged by the borrower as collateral for the loan via the webpage.
